(19) United States
(12) Patent Application Publication
(10) Pub. No.: US 2023/0337220 A1
(43) Pub. Date: Oct. 19, 2023

(54) PERIODIC SCHEDULING OF MULTIPLE UNIQUE SETS OF TRANSPORT BLOCKS

(71) Applicant: QUALCOMM Incorporated, San Diego, CA (US)

(72) Inventors: Huilin Xu, Temecula, CA (US); Yuchul Kim, San Diego, CA (US); Wei Yang, San Diego, CA (US); Jing Sun, San Diego, CA (US); Mostafa Khoshnevisan, San Diego, CA (US); Ahmed Abdelaziz Ibrahim Abdelaziz Zewail, San Diego, CA (US); Jay Kumar Sundararajan, San Diego, CA (US); Nicolas Cornillet, Lannion (FR); Yeliz Tokgoz, San Diego, CA (US); Linhai He, San Diego, CA (US)

(21) Appl. No.: 18/167,311

(22) Filed: Feb. 10, 2023

Related U.S. Application Data
(60) Provisional application No. 63/330,616, filed on Apr. 13, 2022.

(51) Int. Cl. H04W 72/1263; H04W 72/20; H04L 1/1812

(52) U.S. Cl. CPC H04W 72/1263; H04W 72/20; H04L 1/1812

(57) ABSTRACT

Methods, systems, and devices for wireless communications are described. The method may include a user equipment (UE) receiving one or more first messages that indicate one or more configurations for communications between the UE and a network entity during a plurality of periodic communication occasions. The method may also include receiving a control message that activates at least one of the one or more configurations and schedules multiple instances of the communications. Upon receiving the control message, the UE may communicate the multiple instances in accordance with the at least one of the one or more configurations, each of the multiple instances including a different set of transport blocks.

### CROSS REFERENCE

The present application for patent claims the benefit of U.S. Provisional Patent Application No. 63/330,616 by XU et al., entitled “PERIODIC SCHEDULING OF MULTIPLE UNIQUE SETS OF TRANSPORT BLOCKS,” filed Apr. 13, 2022, assigned to the assignee hereof, and expressly incorporated by reference herein.

### FIELD OF TECHNOLOGY

The following relates to wireless communications, including periodic scheduling of multiple unique sets of transport blocks (TBs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities (e.g., one or more base stations), each supporting wireless communication for communication devices, which may be known as user equipment (UE).

Some wireless communications systems may support periodic communication between devices. Two types of periodic communication may be via semi-persistent scheduling (SPS) or a configured grant (CG). To activate SPS or the CG, a UE may receive a control message (e.g., downlink control information (DCI) message) from a network entity activating SPS or the CG. Upon receiving the control message, the UE may transmit or receive signaling over repeating sets of resources until receiving a second control message deactivating SPS or the CG.

### SUMMARY

The described techniques relate to improved methods, systems, devices, and apparatuses that support periodic scheduling of multiple unique sets of transport blocks (TB). For example, the described techniques provide for a user equipment (UE) to transmit multiple sets of unique TBs during one or more periodic occasions. In some examples, the UE may receive a first message from a network entity. The first message may include an indication of one or more configurations for communication between the UE and the network entity during a set of periodic occasions. Further, the UE may potentially receive a control message activating at least one configuration of the one or more configurations. Additionally, the control message may schedule multiple instances of the communication. Upon receiving the control message, the UE may communicate the multiple instances in accordance to the at least one configuration and in some examples, each instance may be an example of a different or unique set of TBs.

A method for wireless communication at a UE is described. The method may include receiving one or more first messages that collectively indicate one or more configurations for communications between the UE and a network entity during a set of multiple periodic communication occasions, each configuration of the one or more configurations indicating a respective periodicity associated with the set of multiple periodic communication occasions, receiving a control message that activates at least one of the one or more configurations for the communications between the UE and the network entity during the set of multiple periodic communication occasions, the control message scheduling multiple instances of the communications, and communicating, based on receiving the control message, the multiple instances in accordance with the at least one of the one or more configurations, each of the multiple instances including a different set of TBs.

An apparatus for wireless communication at a UE is described. The apparatus may include a processor, memory coupled with the processor, and instructions stored in the memory. The instructions may be executable by the processor to cause the apparatus to receive one or more first messages that collectively indicate one or more configurations for communications between the UE and a network entity during a set of multiple periodic communication occasions, each configuration of the one or more configurations indicating a respective periodicity associated with the set of multiple periodic communication occasions, receive a control message that activates at least one of the one or more configurations for the communications between the UE and the network entity during the set of multiple periodic communication occasions, the control message scheduling multiple instances of the communications, and communicate, based on receiving the control message, the multiple instances in accordance with the at least one of the one or more configurations, each of the multiple instances including a different set of TBs.

Another apparatus for wireless communication at a UE is described. The apparatus may include means for receiving one or more first messages that collectively indicate one or more configurations for communications between the UE and a network entity during a set of multiple periodic communication occasions, each configuration of the one or more configurations indicating a respective periodicity associated with the set of multiple periodic communication occasions, means for receiving a control message that activates at least one of the one or more configurations for the communications between the UE and the network entity during the set of multiple periodic communication occasions, the control message scheduling multiple instances of the communications, and means for communicating, based on receiving the control message, the multiple instances in accordance with the at least one of the one or more configurations, each of the multiple instances including a different set of TBs.

A non-transitory computer-readable medium storing code for wireless communication at a UE is described. The code may include instructions executable by a processor to receive one or more first messages that collectively indicate one or more configurations for communications between the UE and a network entity during a set of multiple periodic communication occasions, each configuration of the one or more configurations indicating a respective periodicity associated with the set of multiple periodic communication occasions, receive a control message that activates at least one of the one or more configurations for the communications between the UE and the network entity during the set of multiple periodic communication occasions, the control message scheduling multiple instances of the communications, and communicate, based on receiving the control message, the multiple instances in accordance with the at least one of the one or more configurations, each of the multiple instances including a different set of TB s.

In some examples of the method, apparatuses, and non-transitory computer-readable medium described herein, receiving the control message may include operations, features, means, or instructions for identifying a schedule for communicating the multiple instances of the communications, where the multiple instances may be associated with a same configuration of the one or more configurations and may be scheduled within a same periodic communication occasion associated with the same configuration.

In some examples of the method, apparatuses, and non-transitory computer-readable medium described herein, receiving the control message may include operations, features, means, or instructions for identifying a schedule for communicating the multiple instances of the communications, where the multiple instances may be each associated with a respective different configuration of the one or more configurations and may be each scheduled within a respective different periodic communication occasion associated with the respective different configuration.

In some examples of the method, apparatuses, and non-transitory computer-readable medium described herein, receiving the control message may include operations, features, means, or instructions for receiving the control message indicating a set of multiple pairs of a start and length indicator value (SLIV) and a corresponding slot offset value, where each pair of the set of multiple pairs corresponds to an instance of the multiple instances.

In some examples of the method, apparatuses, and non-transitory computer-readable medium described herein, a slot offset value indicates a number of slots between a slot for receiving the control message and a slot for a periodic communication occasion of the set of multiple periodic communication occasions and a SLIV indicates a starting symbol and a number of consecutive symbols for communicating an instance of the multiple instances.

In some examples of the method, apparatuses, and non-transitory computer-readable medium described herein, communicating the multiple instance may include operations, features, means, or instructions for communicating an instance of the multiple instances according to a corresponding pair of the set of multiple pairs.

In some examples of the method, apparatuses, and non-transitory computer-readable medium described herein, a number of pairs corresponding to the set of multiple pairs may be equal to a number of configurations corresponding to the at least one configuration.

In some examples of the method, apparatuses, and non-transitory computer-readable medium described herein, a number of configurations corresponding to the at least one configuration indicates a threshold and a number of configurations corresponding to the one or more configuration or a number of pairs corresponding to the set of multiple pairs may be equal to or above the threshold.

In some examples of the method, apparatuses, and non-transitory computer-readable medium described herein, resources for communicating the multiple instances include resources associated with a same frequency domain resource allocation (FDRA), a same modulation and coding scheme (MCS), or both.

Some examples of the method, apparatuses, and non-transitory computer-readable medium described herein may further include operations, features, means, or instructions for determining a hybrid automatic repeat request (HARQ) process identifier (ID) for a first instance of the multiple instances.

In some examples of the method, apparatuses, and non-transitory computer-readable medium described herein, determining the HARQ process ID may include operations, features, means, or instructions for inputting a slot for communicating the first instance of the multiple instances into an algorithm, where an output of the algorithm may be the HARQ process ID.

Some examples of the method, apparatuses, and non-transitory computer-readable medium described herein may further include operations, features, means, or instructions for incrementing the HARQ process ID associated with the first instance by one, where a HARQ process ID associated with a second instance of the multiple instances includes the HARQ process ID associated with the first instance by one.

Some examples of the method, apparatuses, and non-transitory computer-readable medium described herein may further include operations, features, means, or instructions for transmitting a second message including feedback information for a first instance of the multiple instances.

Some examples of the method, apparatuses, and non-transitory computer-readable medium described herein may further include operations, features, means, or instructions for determining a slot for transmitting the second message based on a slot offset value, where the slot offset value indicates a number of slots between a slot for communicating the first instance of the multiple instances and a slot for transmitting the second message.

Some examples of the method, apparatuses, and non-transitory computer-readable medium described herein may further include operations, features, means, or instructions for determining, based on the slot offset value, a slot for transmitting a third message including feedback information for a second instance of the multiple instances.

In some examples of the method, apparatuses, and non-transitory computer-readable medium described herein, the second message further includes feedback information for a second instance of the multiple instances.

In some examples of the method, apparatuses, and non-transitory computer-readable medium described herein, receiving the control message may include operations, features, means, or instructions for receiving the control message that activates a first configuration and a second configuration of the one or more configurations for communications between the UE and the network entity during the set of multiple periodic communication occasions.

In some examples of the method, apparatuses, and non-transitory computer-readable medium described herein, communicating the multiple instances may include operations, features, means, or instructions for communicating a first set of TBs in accordance with the first configuration during a periodic communication occasion associated with the first configuration and communicating a second set of TBs in accordance with the second configuration during a periodic communication occasion associated with the second configuration, where the first set of TBs may be different from the second set of TBs.

In some examples of the method, apparatuses, and non-transitory computer-readable medium described herein, a HARQ process number field included in the control message indicates the first configuration and the second configuration.

Some examples of the method, apparatuses, and non-transitory computer-readable medium described herein may further include operations, features, means, or instructions for deactivating a third configuration of the one or more configurations for communications between the UE and the network entity during the set of multiple periodic communication occasions based on receiving the control message.

Some examples of the method, apparatuses, and non-transitory computer-readable medium described herein may further include operations, features, means, or instructions for deactivating the first configuration and the second configuration based on an expiration of a timer and activating a third configuration for communications between the UE and the network entity during the set of multiple periodic communication occasions based on the expiration of the timer.

Some examples of the method, apparatuses, and non-transitory computer-readable medium described herein may further include operations, features, means, or instructions for deactivating the first configuration and the second configuration for a duration based on receiving a second control message and activating the first configuration and the second configuration based on expiration of a timer.

In some examples of the method, apparatuses, and non-transitory computer-readable medium described herein, receiving the control message may include operations, features, means, or instructions for receiving the control message that activates a single configuration of the one or more configurations for communications between the UE and the network entity during the set of multiple periodic communication occasions.

In some examples of the method, apparatuses, and non-transitory computer-readable medium described herein, communicating the multiple instances may include operations, features, means, or instructions for communicating a first set of TBs and a second set of TBs in accordance with the single configuration during a periodic communication occasion associated with the single configuration, where the first set of TBs may be different from the second set of TBs.

In some examples of the method, apparatuses, and non-transitory computer-readable medium described herein, the control message includes a downlink control information (DCI) message.

In some examples of the method, apparatuses, and non-transitory computer-readable medium described herein, the one or more configurations for communications between the UE and the network entity include at least one CG configuration, at least one SPS configuration, or both.

A method for wireless communication at a network entity is described. The method may include transmitting one or more first messages that collectively indicate one or more configurations for communications between a UE and the network entity during a set of multiple periodic communication occasions, each configuration of the one or more configurations indicating a respective periodicity associated with the set of multiple periodic communication occasions, transmitting a control message that activates at least one of the one or more configurations for the communications between the UE and the network entity during the set of multiple periodic communication occasions, the control message scheduling multiple instances of the communications, and communicating, based on transmitting the control message, the multiple instances in accordance with the at least one of the one or more configurations, each of the multiple instances including a different set of TBs.

An apparatus for wireless communication at a network entity is described. The apparatus may include a processor, memory coupled with the processor, and instructions stored in the memory. The instructions may be executable by the processor to cause the apparatus to transmit one or more first messages that collectively indicate one or more configurations for communications between a UE and the network entity during a set of multiple periodic communication occasions, each configuration of the one or more configurations indicating a respective periodicity associated with the set of multiple periodic communication occasions, transmit a control message that activates at least one of the one or more configurations for the communications between the UE and the network entity during the set of multiple periodic communication occasions, the control message scheduling multiple instances of the communications, and communicate, based on transmitting the control message, the multiple instances in accordance with the at least one of the one or more configurations, each of the multiple instances including a different set of TBs.

Another apparatus for wireless communication at a network entity is described. The apparatus may include means for transmitting one or more first messages that collectively indicate one or more configurations for communications between a UE and the network entity during a set of multiple periodic communication occasions, each configuration of the one or more configurations indicating a respective periodicity associated with the set of multiple periodic communication occasions, means for transmitting a control message that activates at least one of the one or more configurations for the communications between the UE and the network entity during the set of multiple periodic communication occasions, the control message scheduling multiple instances of the communications, and means for communicating, based on transmitting the control message, the multiple instances in accordance with the at least one of the one or more configurations, each of the multiple instances including a different set of TBs.

A non-transitory computer-readable medium storing code for wireless communication at a network entity is described. The code may include instructions executable by a processor to transmit one or more first messages that collectively indicate one or more configurations for communications between a UE and the network entity during a set of multiple periodic communication occasions, each configuration of the one or more configurations indicating a respective periodicity associated with the set of multiple periodic communication occasions, transmit a control message that activates at least one of the one or more configurations for the communications between the UE and the network entity during the set of multiple periodic communication occasions, the control message scheduling multiple instances of the communications, and communicate, based on transmitting the control message, the multiple instances in accordance with the at least one of the one or more configurations, each of the multiple instances including a different set of TBs.

In some examples of the method, apparatuses, and non-transitory computer-readable medium described herein, transmitting the control message may include operations, features, means, or instructions for transmitting a schedule for communicating the multiple instances of the communications, where the multiple instances may be associated with a same configuration of the one or more configurations and may be scheduled within a same periodic communication occasion associated with the same configuration.

In some examples of the method, apparatuses, and non-transitory computer-readable medium described herein, transmitting the control message may include operations, features, means, or instructions for transmitting a schedule for communicating the multiple instances of the communications, where the multiple instances may be each associated with a respective different configuration of the one or more configurations and may be each scheduled within a respective different periodic communication occasion associated with the respective different configuration.

In some examples of the method, apparatuses, and non-transitory computer-readable medium described herein, transmitting the control message may include operations, features, means, or instructions for transmitting the control message indicating a set of multiple pairs of a SLIV and a corresponding slot offset value, where each pair of the set of multiple pairs corresponds to an instance of the multiple instances.

In some examples of the method, apparatuses, and non-transitory computer-readable medium described herein, a slot offset value indicates a number of slots between a slot for receiving the control message and a slot for a periodic communication occasion of the set of multiple periodic communication occasions and a SLIV indicates a starting symbol and a number of consecutive symbols for communicating an instance of the multiple instances.

In some examples of the method, apparatuses, and non-transitory computer-readable medium described herein, communicating the multiple instance may include operations, features, means, or instructions for communicating an instance of the multiple instances according to a corresponding pair of the set of multiple pairs.

In some examples of the method, apparatuses, and non-transitory computer-readable medium described herein, a number of pairs corresponding to the set of multiple pairs may be equal to a number of configurations corresponding to the at least one configuration.

In some examples of the method, apparatuses, and non-transitory computer-readable medium described herein, a number of configurations corresponding to the at least one configuration indicates a threshold and a number of configurations corresponding to the one or more configuration or a number of pairs corresponding to the set of multiple pairs may be equal to or above the threshold.

In some examples of the method, apparatuses, and non-transitory computer-readable medium described herein, resources for communicating the multiple instances include resources associated with a same FDRA, a same MCS, or both.

Some examples of the method, apparatuses, and non-transitory computer-readable medium described herein may further include operations, features, means, or instructions for determining a HARQ process ID for a first instance of the multiple instances.

In some examples of the method, apparatuses, and non-transitory computer-readable medium described herein, determining the HARQ process ID may include operations, features, means, or instructions for inputting a slot for communicating the first instance of the multiple instances into an algorithm, where an output of the algorithm may be the HARQ process ID.

Some examples of the method, apparatuses, and non-transitory computer-readable medium described herein may further include operations, features, means, or instructions for incrementing the HARQ process ID associated with the first instance by one, where a HARQ process ID associated with a second instance of the multiple instances includes the HARQ process ID associated with the first instance by one.

In some examples of the method, apparatuses, and non-transitory computer-readable medium described herein, transmitting the control message may include operations, features, means, or instructions for transmitting the control message that activates a first configuration and a second configuration of the one or more configurations for communications between the UE and the network entity during the set of multiple periodic communication occasions.

In some examples of the method, apparatuses, and non-transitory computer-readable medium described herein, communicating the multiple instances may include operations, features, means, or instructions for communicating a first set of TBs in accordance with the first configuration during a periodic communication occasion associated with the first configuration and communicating a second set of TBs in accordance with the second configuration during a periodic communication occasion associated with the second configuration, where the first set of TBs may be different from the second set of TBs.

In some examples of the method, apparatuses, and non-transitory computer-readable medium described herein, a HARQ process number field included in the control message indicates the first configuration and the second configuration.

Some examples of the method, apparatuses, and non-transitory computer-readable medium described herein may further include operations, features, means, or instructions for deactivating a third configuration of the one or more configurations for communications between the UE and the network entity during the set of multiple periodic communication occasions based on transmitting the control message.

Some examples of the method, apparatuses, and non-transitory computer-readable medium described herein may further include operations, features, means, or instructions for deactivating the first configuration and the second configuration based on an expiration of a timer and activating a third configuration for communications between the UE and the network entity during the set of multiple periodic communication occasions based on the expiration of the timer.

Some examples of the method, apparatuses, and non-transitory computer-readable medium described herein may further include operations, features, means, or instructions for deactivating the first configuration and the second configuration for a duration based on transmitting a second control message and activating the first configuration and the second configuration based on expiration of a timer.

In some examples of the method, apparatuses, and non-transitory computer-readable medium described herein, transmitting the control message may include operations, features, means, or instructions for transmitting the control message that activates a single configuration of the one or more configurations for communications between the UE and the network entity during the set of multiple periodic communication occasions.

In some examples of the method, apparatuses, and non-transitory computer-readable medium described herein, communicating the multiple instances may include operations, features, means, or instructions for communicating a first set of TBs and a second set of TBs in accordance with the single configuration during a periodic communication occasion associated with the single configuration, where the first set of TBs may be different from the second set of TBs.

In some examples of the method, apparatuses, and non-transitory computer-readable medium described herein, the control message includes a DCI message.

In some examples of the method, apparatuses, and non-transitory computer-readable medium described herein, the one or more configurations for communications between the UE and the network entity include at least one CG configuration, at least one SPS configuration, or both.

### BRIEF DESCRIPTION OF THE DRAWINGS

FIGS. 1 and 2 illustrate examples of a wireless communications system that supports periodic scheduling of multiple unique sets of transport blocks (TBs) in accordance with one or more aspects of the present disclosure.

FIGS. 3 and 4 illustrate examples of a periodic communication scheme that supports periodic scheduling of multiple unique sets of TBs in accordance with one or more aspects of the present disclosure.

FIG. 5 illustrates an example of a process flow that supports periodic scheduling of multiple unique sets of TBs in accordance with one or more aspects of the present disclosure.

FIGS. 6 and 7 show block diagrams of devices that support periodic scheduling of multiple unique sets of TBs in accordance with one or more aspects of the present disclosure.

FIG. 8 shows a block diagram of a communications manager that supports periodic scheduling of multiple unique sets of TBs in accordance with one or more aspects of the present disclosure.

FIG. 9 shows a diagram of a system including a device that supports periodic scheduling of multiple unique sets of TBs in accordance with one or more aspects of the present disclosure.

FIGS. 10 and 11 show block diagrams of devices that support periodic scheduling of multiple unique sets of TBs in accordance with one or more aspects of the present disclosure.

FIG. 12 shows a block diagram of a communications manager that supports periodic scheduling of multiple unique sets of TBs in accordance with one or more aspects of the present disclosure.

FIG. 13 shows a diagram of a system including a device that supports periodic scheduling of multiple unique sets of TBs in accordance with one or more aspects of the present disclosure.

FIGS. 14 through 19 show flowcharts illustrating methods that support periodic scheduling of multiple unique sets of TBs in accordance with one or more aspects of the present disclosure.

### DETAILED DESCRIPTION

In some examples, a user equipment (UE) may be configured to utilize semi-persistent scheduling (SPS) or configured grants (CG). That is, the UE may have the ability to transmit signals to or receive signals from a network entity (e.g., a base station) over a repeating set of resources or during multiple repeating periodic occasions (e.g., SPS periods or CG periods). In some examples, the UE may receive a control message (e.g., a downlink control information (DCI) message or a radio resource control (RRC) message) from the network entity activating SPS or CG (e.g., Type 1 CG or Type 2 CG). Upon receiving the control message, the UE may transmit signals to or receive signals from the network entity during the multiple repeating periodic occasions. In some examples, during a single periodic occasion, the UE may transmit or receive multiple physical downlink shared channels (PDSCHs) or physical uplink shared channels (PUSCHs), where each PDSCH or PUSCH carries one or more transport blocks (TBs) that convey the same information.

Further, the UE may be configured with multiple SPS or CG configurations, where different SPS or CG configurations may indicate different periodicities (e.g., duration between each periodic occasion). In some examples, the control message may activate a single SPS or CG configuration of the multiple SPS or CG configurations. However, for some applications (e.g., extended reality (XR)), it may be beneficial to communicate multiple PDSCHs or PUSCHs during a single periodic occasion, where each PUSCH or PDSCH includes different information or to activate multiple SPS or CG configurations using a single control message.

As described herein, a UE may receive a single control message activating multiple SPS or CG configurations or the UE may transmit multiple unique sets of TBs over a single periodic occasion. In some examples, the UE may be configured with one or more SPS or CG configurations. Further, the UE may receive a control message (e.g., a DCI message or an RRC message). In one example, the control message may activate multiple SPS or CG configurations (e.g., Type 1 or Type 2 CG configurations). In such example, the control message may include an indication of the SPS or CG configurations of the one or more SPS or CG configurations to activate. Each SPS or CG configuration may correspond to a respective PDSCH or PUSCH, where each PDSCH or PUSCH carries a unique subset of TBs (e.g., one or more TBs) of a set TBs to be communicated between the UE and the network entity. Upon receiving the control message, the UE may transmit or receive the respective subset of TBs respective TBs according to the corresponding SPS or CG configuration.

In another example, the control message may indicate for the UE to transmit a series of unique PDSCHs or PUSCHs during a periodic occasion according to a single SPS or CG configuration. In such example, the control message may include indication of the SPS or CG configuration to use. The SPS or CG configuration may correspond to a set of unique PDSCHs or PUSCHs or unique subsets of TBs (e.g., indicated in the control message). Upon receiving the control message, the UE may transmit the unique subsets of TBs during each periodic occasion according to the SPS or CG configuration.

Aspects of the disclosure are initially described in the context of wireless communications systems. Additional aspects are described in context of periodic communications schemes and a process flow. Aspects of the disclosure are further illustrated by and described with reference to apparatus diagrams, system diagrams, and flowcharts that relate to periodic scheduling of multiple unique sets of TBs.

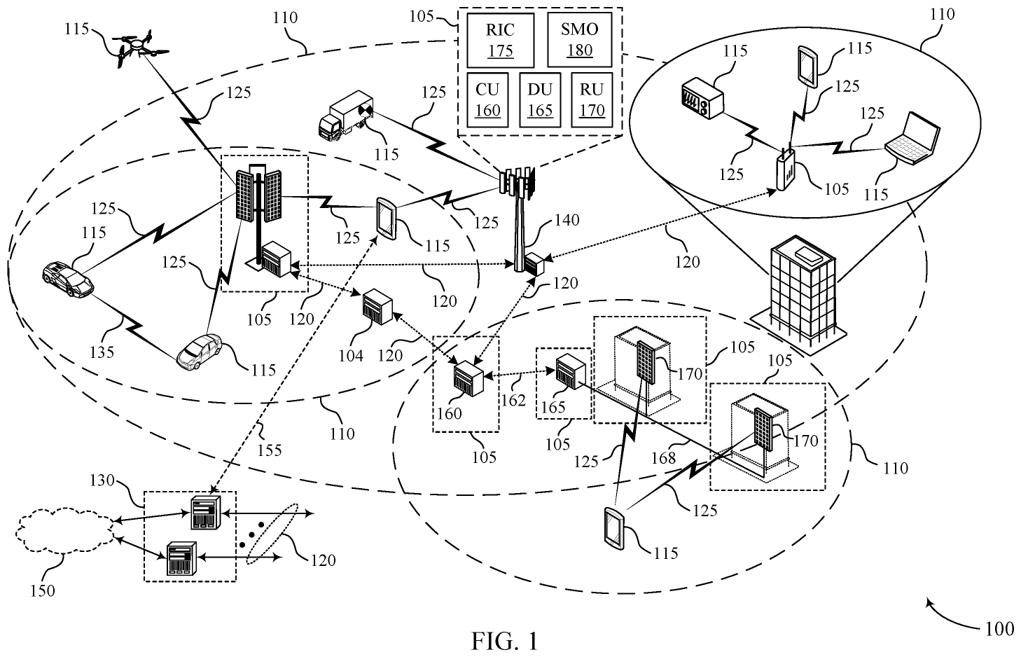

FIG. 1 illustrates an example of a wireless communications system 100 that supports periodic scheduling of multiple unique sets of TBs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support periodic scheduling of multiple unique sets of TBs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

As described herein, the UE 115 may transmit multiple unique sets of TBs during one or more periodic occasions (e.g., SPS periods or CG periods). In some examples, the UE 115 may receive a first message from the network entity 105. The first message may include an indication of one or more configurations for communication between the UE 115 and the network entity 105 during a set of periodic occasions. Further, the UE 115 may receive a control message activating at least one configuration of the one or more configurations. Additionally, the control message may schedule multiple instances of the communication. Upon receiving the control message, the UE 115 may communicate the multiple instances in accordance to the at least one configuration and in some examples, each instance may be an example of a different or unique set of TBs.

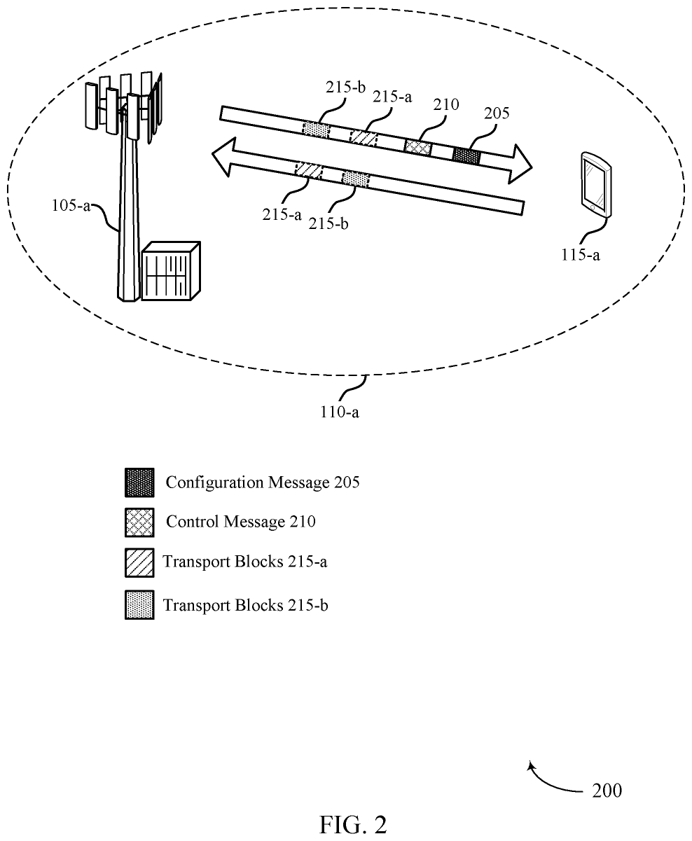

FIG. 2 illustrates an example of a wireless communications system 200 that supports periodic scheduling of multiple unique sets of TBs in accordance with one or more aspects of the present disclosure. In some examples, the wireless communications system 200 may support aspects of a wireless communications system 100. For example, the wireless communications system 200 may include a network entity 105-a and a UE 115-a which may be examples of a network entity 105 and a UE 115 as described with reference to FIG. 1. In some examples, the UE 115-a and the network entity 105-a may be located in a coverage area 110-a.

In some examples, the wireless communications system 200 may support periodic communication. Examples of periodic communication may be SPS or CGs (e.g., Type 1 CG or Type 2 CG). In some examples, prior to implementing the periodic communication, the network entity 105-a may configure the UE 115-a with a set of configurations. Configurations included in the set of configurations may include information that the UE 115-a may utilize when implementing the periodic communication. For example, a configuration of the set of configurations may include an indication of a periodicity and in some examples, the indicated periodicity may be different for each configuration of the set of configurations. A periodicity may refer to a number of slots between each periodic communication occasion (e.g., SPS occasions or CG occasions).

In some examples, the UE 115-a may not utilize periodic communication immediately upon configuration. Instead, the UE 115-a may receive a control message 210 from the network entity 105-a activating the periodic communication. In one example, the UE 115-a may receive a DCI message activating an SPS configuration of a set of SPS configurations. The SPS configuration may be indicated by a HARQ process number field of the DCI (e.g., sps-ConfigIndex). Upon receiving the DCI message, the UE 115-a may activate the SPS configuration. That is, the UE 115-a may receive signaling over a set of reoccurring resources or during a set of SPS occasions (or SPS periods) according to the SPS configuration (e.g., the periodicity indicated by the SPS configuration). In some examples, the UE 115-a may receive a single PDSCH that carries a set of TBs during each SPS occasion, where the set of TBs may include one or more TBs. In another example, the UE 115-a may receive two or more identical PDSCHs carrying a set of TBs during each SPS occasion, where the set of TBs may include one or more TBs.

The DCI message may also include an indication of a first slot offset value (e.g., K1), one or more of a second slot offset value (e.g., K0), and one or more of a start and length indicator (SLIV). In some examples, the DCI message may include a reference to a row index of a time domain resource allocation (TDRA) table, where each row of the TDRA table includes a combination of the second slot offset and the SLIV. The number of combinations in the row may correspond to the number of identical PDSCHs or identical set of TBs received during an SPS occasion. The first offset value may indicate a number of slots between the slot used to receive a last set of TBs of an SPS occasion and a slot used to transmit feedback for the one or more identical sets of TBs transmitted during the SPS occasion. The second offset value may indicate a number slots between a slot used to receive the DCI message and a slot used to receive a corresponding set of TBs and the SLIV may indicate a starting symbol and a number of consecutive symbols used to receive the corresponding set of TBs. To release the SPS configuration, the UE 115-a may receive a second DCI message from the network entity 105-a deactivating the SPS configuration. In some examples, the second DCI message may deactivate more than one SPS configuration. In such example, the SPS configuration to be released may be indicated by a HARQ process number field in the DCI second message (e.g., sps-ConfigDeactivationStateList).

In other examples, the UE 115-a may receive a control message 210 activating a CG configuration of a set of CG configurations. The control message 210 may include a DCI message for Type 2 CG configurations or the control message 210 may include an RRC message for Type 1 CG configurations. Further, for Type 2 CG, the CG configuration may be indicated by a HARQ process number field of the DCI (e.g., ConfiguredGrantConfigIndex). For Type 1 CG, the CG configuration may be indicated by an IE in the RRC message (e.g., ConfiguredGrantConfig). Upon receiving the control message 210, the UE 115-a may activate the CG configuration. That is, the UE 115-a may transmit signaling over a set of reoccurring resources or during a set of CG occasions (or CG periods) according to the CG configuration (e.g., according to the periodicity indicated in the CG configuration). In some examples, the UE 115-a may transmit a single PUSCH that carries a set of TBs during each CG occasion. In another example, the UE 115-a may transmit two or more identical PUSCHs that carries a set of TBs during each CG occasion.

The control message 210 (e.g., the DCI message or the RRC message) may also include an indication of one or more of a third slot offset value (e.g., K2) and one or more of a start and length indicator (SLIV). In some examples, the control message 210 (e.g., a TDRA field in DCI or a timeDomainAllocation field in RRC) may include a reference to a row index of a TDRA table, where each row of the TDRA table includes a combination of the third slot offset and the SLIV. The number of combinations in the row may correspond to the number of identical PUSCHs or identical sets of TBs transmitted during a CG occasion (or CG period). The third offset value may indicate a number slots between a slot used to receive the control message 210 and a slot used to transmit a corresponding set of TBs and the SLIV may indicate a starting symbol and a number of consecutive symbols used to transmit the corresponding set of TBs. To release the CG configuration, the UE 115-a may receive a second control message (e.g., a second DCI message) from the network entity 105-a deactivating the CG configuration. In some examples, the second control message may deactivate more than one CG configuration. In such example, the CG configurations to be released may be indicated by a HARQ process number field in the control message 210 (e.g., ConfiguredGrantConfigType2DeactivationStateList in DCI).

As described above, the UE 115-a may receive a control message 210 activating a single configuration for periodic communication with the network entity 105-a and upon activation, the UE 115-a may transmit one or more identical sets of TBs during each periodic occasion according to the configuration. However, in some examples, it may be beneficial for the UE 115-a to perform periodic communication according to multiple configurations. For example, such operations may be beneficial for applications such as extended reality (XR). XR may support multiple services simultaneously, where each service may have a corresponding periodicity. As such, having the ability to activate multiple configurations may be beneficial for XR. Additionally or alternatively, it may be beneficial for the UE 115-a to transmit two or more unique sets of TBs during each periodic occasion according to a configuration. For example, in XR, multiple sets of TBs may be transmitted for a single video. As an example, an average downlink video rate of 30 Mbps has a mean, minimum, and maximum packet size of 62,500, 31,250, or 93,750 bytes. As such, having the ability to transmit multiple unique sets of TBs during a periodic occasion may be beneficial for XR.

As described herein, the UE 115-a may transmit two or more unique sets of TBs over a periodic communication occasion according to a configuration for periodic communication with the network entity 105-a. In some examples, the UE 115-a may receive a configuration message 205. The configuration message 205 may include an indication of one or more configurations for periodic communications with the network entity 105-a. In one example, the one or more configurations may be examples of SPS configurations or CG configurations (e.g., Type 1 or Type 2 CG configurations). In some examples, each configuration of the one or more configurations may include an indication of a periodicity.

In some examples, the UE 115-a may receive a control message 210 (e.g., a DCI message or an RRC message). The control message 210 may activate a configuration of the set of configurations. In the case that the configuration is an SPS configuration, the control message 210 may also include an indication of one or more first slot offset values (e.g., K1), two or more second slot offset values (e.g., K0) and two or more SLIVs. In the case that the configuration is a CG configuration, the control message 210 may also include two or more third slot offset values (e.g., K2) and two or more SLIVs. In some examples, the control message 210 may indicate a row index value mapped to a row of a TDRA table. The TDRA table may include two or more combinations of the second slot offset value or the third slot offset value and the SLIV. Each combination may correspond to a PDSCH or a PUSCH that carries a set of TBs, where each set of TBs is different from one another (e.g., unique). In one example, the sets of TBs may include TBs 215-a and TBs 215-b, where the TBs 215-a are different from the TBs 215-b. As such, the row of the TDRA table indicated by the control message 210 may include two combinations of the second slot offset value or the third slot offset value and the SLIV, a first combination corresponding to the TBs 215-a and a second combination corresponding to the TBs 215-b.

Upon receiving the control message 210, the UE 115-a may communicate the sets of TBs 215 to the network entity 105-a during a periodic communication occasion (e.g., CG period or SPS period) according to the configuration. The UE 115-a may determine a slot for each set of TBs in the periodic communication occasion based on the corresponding second slot offset value or the third slot offset value and the SLIV indicated in the control message 210. In the case of SPS, the UE 115-a may receive the TBs 215-a and the TBs 215-b from the network entity 105-a during an SPS occasion (or an SPS period) according to the configuration. Additionally, the UE 115-a may receive the TBs 215-a and the TBs 215-b from the network entity 105-a during a second SPS occasion that occurs after the SPS occasion according to the configuration, where the SPS occasion and the second SPS occasion are separated by a duration (e.g., duration determined from the periodicity indicated by the SPS configuration). In the case of CGs, the UE 115-a may transmit the TBs 215-a and the TBs 215-b to the network entity 105-a during a CG occasion (e.g., or a CG period) according to the configuration. Additionally, the UE 115-a may transmit the TBs 215-a and the TBs 215-b to the network entity 105-a during a second CG occasion that occurs after the CG occasion according to the configuration, where the CG occasion and the second CG occasion are separated by a duration (e.g., a duration determined from the periodicity indicated by the CG configuration).

In another example, the techniques described herein may support a UE 115-a receiving the control message 210 activating two or more configurations for periodic communication with the network entity 105-a. In some examples, the UE 115-a may receive the configuration message 205. The configuration message 205 may include an indication of two or more configurations for periodic communications with the network entity 105-a. In one example, the two or more configurations may be examples of SPS occasions or CG configurations. In some examples, each configuration of the one or more configurations may include an indication of a periodicity.

In some examples, the UE 115-a may receive the control message 210 (e.g., a DCI message or an RRC message). The control message 210 may activate two or more configurations of the set of configurations. In the case that the configurations are SPS configurations, the control message 210 may also include an indication of one or more first slot offset values (e.g., K1), two or more second slot offset values (e.g., K0), and two or more SLIVs. In the case that the two or more configurations are CG configurations, the control message 210 may include two or more third slot offset values (e.g., K2) and two or more SLIVs. In some examples, the control message 210 may indicate a row index value mapped to a row of a TDRA table. The TDRA table may include two or more combinations of the second slot offset value or the third slot offset value and the SLIV. Each combination may correspond to a PUSCH or PDSCH that carries a set of TBs 215, where each set of TBs 215 is different from one another (e.g., unique). In one example, the sets of TBs 215 may include TBs 215-a and TBs 215-b, where the TBs 215-a are different from the TBs 215-b. As such, the row of the TDRA table indicated by the control message may include two combinations of the second slot offset value or the third slot offset value and the SLIV, a first combination corresponding to the TBs 215-a and a second combination corresponding to the TBs 215-b. Additionally, a number of combinations include in the row may be equal to a number of configurations indicated in the control message 210. As such, in the case that the row includes the first combination and the second combination, the number of configurations indicated in the control message may be two configurations (e.g., a first configuration and a second configuration).

Upon receiving the control message 210, the UE 115-a may communicate the sets of TBs 215 according to the two or more configurations. The UE 115-a may determine a slot for each set of TBs 215 based on the corresponding second slot offset value or third slot offset value and the SLIV. In the case of SPS, the UE 115-a may receive the TBs 215-a during an SPS occasion according to the first configuration and receive the TBs 215-b during an SPS occasion according to the second configuration. Additionally, the UE 115-a may receive the TBs 215-a during a second SPS occasion according to the first configuration and receive the TBs 215-b during a second SPS occasion according to the second configuration. The SPS occasion and the second SPS corresponding to the first configuration may be separated by a duration (e.g., a duration determine from the periodicity indicated by the first configuration). The SPS occasion and the second SPS corresponding to the second configuration may be separated by a second duration (e.g., a duration determined from the periodicity indicated by the second configuration). In the case of CGs, the UE 115-a may transmit the TBs 215-a during a CG occasion according to the first configuration and transmit the TBs 215-b during a CG occasion according to the second configuration. Additionally, the UE 115-a may transmit the TBs 215-a during a second CG occasion according to the first configuration and transmit the TBs 215-b during a second CG occasion according to the second configuration. The CG occasion and the second CG corresponding to the first configuration may be separated by a duration (e.g., a duration determined from the periodicity indicated by the first configuration). The CG occasion and the second CG corresponding to the second configuration may be separated by a second duration (e.g., a duration determine from the periodicity indicated by the second configuration).

In some examples, the UE 115-a may determine to perform an operation from a set of operations for periodic communication with a network entity 105-a when the UE 115-a is configured with two or more configurations. The set of operations may include a first operation and a second operation. The first operation may include the UE 115-a transmitting two or more unique sets of TBs over a periodic communication occasion according to a configuration for periodic communication with the network entity 105-a. The second operations may include the UE 115-a receiving the control message 210 activating two or more configurations for periodic communication with the network entity 105-a. In some examples, the UE 115-a may receive a configuration message (e.g., an RRC message) indicating the operation of the set of operations (e.g., the first operation or the second operation) and perform the operation based on receiving the configuration message. In another example, the control message 210 may indicate the operation (e.g., the first operation or the second operation) and the UE 115-a may perform the operation based on receiving the control message 210. In another example, the UE 115-a may be configured with a single configuration and select the first operation based on being configured with a single configuration.

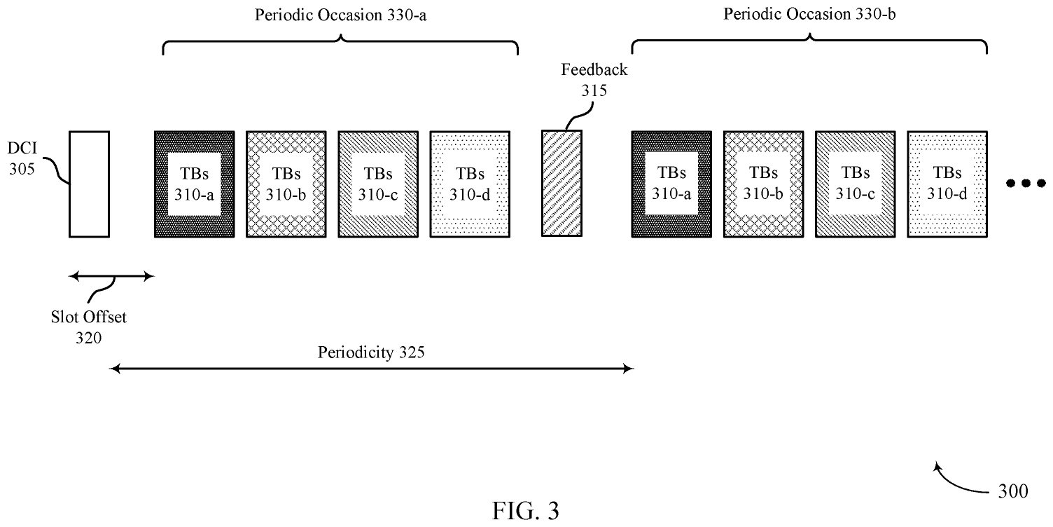

FIG. 3 illustrates an example of a periodic communication scheme 300 that supports periodic scheduling of multiple unique sets of TBs in accordance with one or more aspects of the present disclosure. In some examples, the periodic communication scheme 300 may be implemented by aspects of a wireless communications system 100 and a wireless communications system 200. For example, the periodic communication scheme 300 may be implemented by a UE 115 as described with reference to FIGS. 1 and 2.

As described in FIG. 2, a UE may receive a control message (e.g., a DCI message or an RRC message) activating a configuration for periodic communication with a network entity and upon receiving the control message, transmit or receive a set of TBs 310 to the network entity during a periodic occasion 330 (e.g., SPS periods or CG periods) according to the configuration. As shown in FIG. 3, the UE may receive DCI 305. DCI 305 may activate a configuration of a set of configurations configured for the UE for periodic communication with the network entity. The configuration may be an example of an SPS configuration (e.g., a configuration for periodic downlink communication) or a Type 2 CG configuration (e.g., a configuration for periodic uplink communication) and may include an indication of a periodicity. The periodicity 325 may refer to a number of slots between periodic occasions 330 (e.g., SPS occasions or CG occasions). In some examples, Type 1 CG configurations may be supported by the methods as described in FIG. 3. In such case, the DCI 305 may be replaced with an RRC message.

The DCI 305 may include an indication of a slot offset 320 (e.g., K0 for SPS and K2 for CG) and a SLIV. In some examples, the DCI 305 may indicate the slot offset 320 and the SLIV as a pair. For example, the DCI 305 may include a row index mapped to a row of a TDRA table, where the row includes the pair. In some examples, the row may include multiple pairs. For example, the row may include four pairs. The number of pairs in the row may be equal to a number of PUSCHs or PDSCHs, where each PUSCH or PDSCH may include (e.g., carry) a subset (e.g., one or more) of TBs 310 included in a set of TBs 310 communicated between the UE and the network entity during a periodic occasion 330. That is, each pair may correspond to a subset of TBs 310. The subsets of TBs 310 (e.g., TBs 310-a, TBs 310-b, TBs 310-c, and TBs 310-d) included in the set may be different from one another. The slot offset 320 of a pair may indicate a number of slots between a slot used to receive the DCI 305 and a slot used to communicate a corresponding subset of TBs 310 during a first periodic occasion (e.g., the periodic occasion 330-a). The SLIV of the pair may indicate a starting symbol and a number of consecutive symbols for the corresponding subset of TBs 310.

Upon receiving the DCI 305, the UE may communicate the set of TBs 310 to the network entity during a periodic occasion 330 (e.g., SPS period or CG period) according to the configuration activated by the DCI 305. For example, in the case of SPS, the UE may receive the TBs 310-a, the TBs 310-b, the TBs 310-c, and the TBs 310-d during the periodic occasion 330-a and in some examples, during the periodic occasion 330-b. In the case of CG, the UE may transmit the TBs 310-a, the TBs 310-b, the TBs 310-c, and the TBs 310-d during the periodic occasion 330-a and in some examples, the periodic occasion 330-b. The slot for each subset of TBs 310 of the set of TBs 310 may be determined using the corresponding slot offset 320 and the SLIV indicated by the DCI 305. In some examples, each subset of TBs 310 of the set of TBs 310 may occupy a same set of frequency resources (e.g., have a same frequency domain resource allocation (FDRA)). Additionally, each subset of TBs 310 of the set of TBs 310 of the set may be transmitted or received using a same MCS. Further, each subset of TBs 310 may have the same (or share) configuration parameters in an RRC message.

In some examples, the UE may determine a HARQ process ID for each subset of TBs 310 of the set of TBs 310. In one example, the UE 115-a may determine the HARQ process ID for a subset of TBs 310 based on a slot used to communicate the subset of TBs 310. For example, the UE may input the slot used to communicate the subset of TBs 310 into an equation and an output of the equation may be the HARQ process ID for the subset of TBs 310. Equation 1 illustrates an example of an equation used to determine the HARQ process ID for a TB 310. In another example, the UE may apply a multiplication factor (or M) to Equation 1 in order to determine a HARQ process ID for a subset of TBs 310 of the set of TBs 310 as represented by Equation 2. M may be equal to the number of subsets of TBs 310 in a periodic occasion 330 (e.g., SPS period or CG period). Using Equation 2 may allow for the HARQ process ID to be continuous between a last subset of TBs 310 in a periodic occasion 330 and a first subset of TBs 310 in an adjacent periodic occasion 330.

HARQ Process ID=[floor(CURRENT_slot×10/(numberofSlotPerFrame×periodicity))]modulo nrofHARQProcesses+harqProcIDOffset (1)

HARQ Process ID=[floor(M×CURRENT_slot×10/(numberofSlotPerFrame×periodicity))]modulo nrofHARQProcesses+harqProcIDOffset (2)

In another example, the UE may determine a HARQ process ID for each subset of TBs 310 of the set of TBs 310 by incrementing the HARQ process ID of a following subset of TBs 310 by an amount. As an example, the UE may determine that the HARQ process ID for the TBs 310-a is one (e.g., using Equation 1 or Equation 2). To determine the HARQ process ID for the TBs 310-b (e.g., the TBs 310 following the TBs 310-b), the UE may increment the HARQ process ID determined for TBs 310-a by one. For example, the UE may increment the HARQ process ID of one by one which may result in a HARQ process ID of two for the TBs 310-b. The pattern may be repeated for the remaining TBs 310 of the set. For example, the UE may determine that the TBs 310-c have a HARQ process ID of three and the TBs 310-d have a HARQ process ID of 4. In some examples, the number of HARQ process IDs that the UE may utilize may be limited (e.g., less than the number of subset of TBs 310 of the set). For example, the UE may be permitted to use two HARQ process IDs or two HARQ processes. In such example, the UE may reuse a HARQ process ID for a subset of TBs 310 of the set. As one example, the UE may determine that TBs 310-a haver a HARQ process ID of one and the TBs 310-b have a HARQ process ID of two (e.g., using the incrementation technique). The remaining TBs 310 (e.g., the TBs 310-c and the TBs 310-d) may reuse the HARQ process ID of one or the HARQ process ID of two. In one example, the UE may determine which TBs 310 have a HARQ process ID of one and HARQ process ID of two using a wraparound approach. That is, the UE may determine that the HARQ process ID for TBs 310-c is one and the HARQ process ID for TBs 310-d is two.

In some examples, the UE may transmit a feedback message 315 to the network entity, where the feedback message includes feedback information related to one or more of the subsets of TBs 310 received during the periodic occasion 330 (e.g., HARQ ACK/NACK feedback). In some examples, a slot for transmitting the feedback message 315 may be determined using a second slot offset value (e.g., K1) indicated in the DCI 305. In one example, the second slot offset value may indicate a number of slots between a slot used to receive a respective subset of TBs 310 and a slot for transmitting the feedback message 315 for the respective subset of TBs 310. In such example, a feedback message 315 may be transmitted for each subset of TBs 310 over resources (e.g., physical uplink control channel (PUCCH) resources) of a different slot. In some examples, the UE may utilize the same second slot offset value for each subset of TBs 310 of the set. In another example, the second slot offset value may indicate a number of slots between the last subset of TBs 310 (e.g., TBs 310-d) received during the periodic occasion 330 and a slot used to transmit the feedback message for all the TBs 310 of the set. In such example, the feedback message 315 may include feedback information corresponding to all of the TBs 310 of the set.

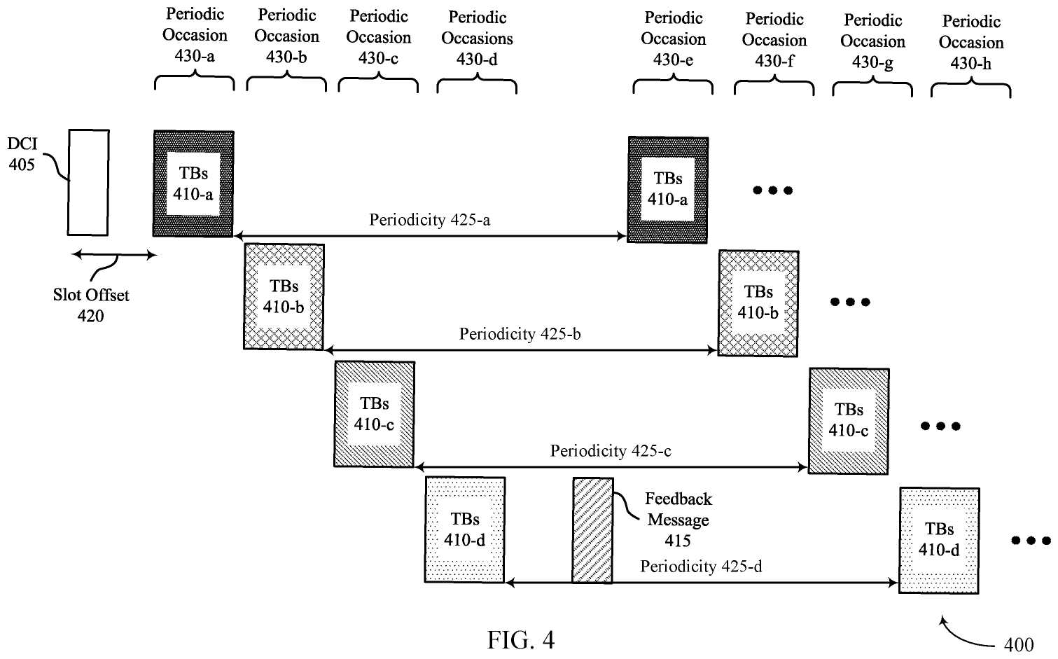

FIG. 4 illustrates an example of a periodic communication scheme 400 that supports periodic scheduling of multiple unique sets of TBs in accordance with one or more aspects of the present disclosure. In some examples, the periodic communication scheme may be implemented by aspects of a wireless communications system 100 and a wireless communications system 200. For example, the periodic communication scheme 400 may be implemented by a UE 115 as described with reference to FIGS. 1 and 2.

As described in FIG. 2, a UE may receive a control message that activates more than one configuration for periodic communication with a network entity. As shown in FIG. 4, the UE may receive DCI 405. DCI 405 may activate more than one configuration of a set of configurations configured for the UE for periodic communication with the network entity. In one example, the DCI 405 may activate four configurations. In some examples, the DCI 405 may indicate the configurations to be activated using a HARQ process number field. The HARQ process number field may point to a set of configurations configured for use by the UE. In one example, the UE may be configured with a list of different sets of configurations via RRC. For example, the RRC configuration may include an information element (IE) (e.g., ConfiguredGrantConfigType2DeactivationStateList or ConfiguredGrantConfigType2ActivationStateList for CG or sps-ConfigDeactivationStateList or sps-ConfigActivationStateList for SPS), where the IE includes a list of different sets of configurations (e.g., up to 16 sets of configurations). The HARQ process number may include an index that points to a set of configurations included in IE or list of configurations. The configurations may be an example of SPS configurations (e.g., configurations for periodic downlink communication) or Type 2 CG configurations (e.g., configurations for periodic uplink communication) and may include an indication of a periodicity 425. The periodicity 425 may refer to a number of slots between periodic occasions 430 (e.g., SPS occasions or CG occasions). In some examples, Type 1 CG configurations may be supported by the methods as described in FIG. 4. In such case, the DCI 405 may be replaced with an RRC message.

In some examples, the DCI 405 may include an indication of a slot offset value (e.g., K0 for SPS and K2 for CG) and a SLIV. In some examples, the DCI 405, the DCI 405 may indicate the slot offset 420 and the SLIV as a pair. For example, the DCI 405 may include a row index mapped to a row of a TDRA table, where the row includes the pair. In some examples, the row may include multiple pairs. For example, the row may include four pairs. The number of pairs in the row may be equal to a number of PUSCHs or PDSCHs, where each PUSCH or PDSCH may include (e.g., carry) a subset (e.g., one or more) of TBs 410 included in a set of TBs 410 communicated between the UE and the network entity during a periodic occasion 430. That is, each pair may correspond to a PUSCH or a PDSCH with a different subset of TBs 410 of the set of TBs 410. The subset of TBs 410 (e.g., the TBs 410-a, the TBs 410-b, the TB 410-c, and the TBs 410-d) included in the set may be different from one another.

Additionally or alternatively, the number of pairs in the row may be equal to a number of configurations indicated in the DCI 405. For example, if the number of configurations is four, the number of pairs in the row may be expected to be four. In another example, the number of active configurations may be equal to a minimum of the number of pairs in the row and a number of configurations configured for the UE (e.g., set of configurations indicated in a control message). The slot offset 420 of a pair may indicate a number of slots between a slot used to receive the DCI 405 and a slot used to communicate a corresponding subset of TBs 410 during a first periodic occasion for a corresponding configuration (e.g., the periodic occasion 430-b, the periodic occasion 430-b, the periodic occasion 430-c, or the periodic occasion 430-d). The SLIV of the pair may indicate a starting symbol and a number of consecutive symbols for the corresponding subset of TBs 410.

Upon receiving the DCI 405, the UE may communicate the set of TBs 410 to the network entity according to the configurations activated by the DCI 305. For example, in the case of SPS, the UE may receive the TBs 410-a during the periodic occasion 430-a of a first configuration, the TBs 410-b during the periodic occasion 430-b of a second configuration, the TBs 410-c during the periodic occasion 430-c of a third configuration, and the TBs 410-d during the periodic occasion 430-d of a fourth configuration. Additionally, the UE may receive the TBs 410-a during the periodic occasion 430-e of a first configuration, the TBs 410-b during the periodic occasion 430-f of a second configuration, the TBs 410-g during the periodic occasion 430-c of a third configuration, and the TBs 410-h during the periodic occasion 430-d of a fourth configuration. In the case of CG, the UE may transmit TBs 410-a during the periodic occasion 430-a of a first configuration, the TBs 410-b during the periodic occasion 430-b of a second configuration, the TBs 410-c during the periodic occasion 430-c of a third configuration, and the TBs 410-d during the periodic occasion 430-d of a fourth configuration. Additionally, the UE may transmit the TBs 410-a during the periodic occasion 430-e of a first configuration, the TBs 410-b during the periodic occasion 430-f of a second configuration, the TBs 410-g during the periodic occasion 430-c of a third configuration, and the TBs 410-h during the periodic occasion 430-d of a fourth configuration. The slot for each subset of TBs 410 of the set may be determined using the corresponding slot offset 420 and the SLIV indicated by the DCI 405. In some examples, each subset of TBs 410 of the set may occupy a same set of frequency resources (e.g., have a same FDRA). Additionally, each subset of TBs 410 of the set may be transmitted or received using a same MCS.

In some examples, the UE may transmit a feedback message 415 to the network entity, where the feedback message 415 includes feedback information related to one or more of the subsets of TBs 410 received during the periodic occasions 430 (e.g., HARQ ACK/NACK feedback). In some examples, a slot for transmitting the feedback message 415 may be determined using a second slot offset value (e.g., K1) indicated in the DCI 405. In one example, the second slot offset value may indicate a number of slots between a slot used to transmit a respective subset of TBs 410 and a slot for transmitting the feedback message 415 for the respective subset of TBs 410. In such example, a feedback message 415 may be transmitted for each subset of TBs 410 over resources (e.g., PUCCH resources) of a different slot. In some examples, the UE may utilize the same second slot offset value for each subset of TBs 410 of the set. In another example, the second slot offset value may indicate a number of slots between a slot used to receive a subset of TBs 410 of the last configuration (e.g., the TB 410-d) and a slot used to transmit the feedback message 415 for all the TBs 410 of the set if a periodicity associated with the activated configurations (e.g., a periodicity 425-a, a periodicity 425-b, a periodicity 425-c, and a periodicity 425-d) is the same. In such example, the feedback message 415 may include feedback information corresponding to all of the TBs 410 of the set.

In some examples, the UE may determine to switch from a first set of configuration to a second set of configurations. In one example, the UE may receive the DCI 405 activating a first set of configurations and at a later time, receive a second DCI 405 activating a second set of configurations. In such example, upon receiving the second DCI 405, the UE may deactivate the first set of configurations and operate in accordance to the second set of configurations. In some examples, the UE may switch back to (e.g., reactivate) the first set of configurations and deactivate the second set of configurations a duration after activating the second set of configurations. In such example, the UE may receive signaling (e.g., RRC signaling or the DCI 405) indicating one or more timers. A timer of the one or more timers may initiate upon activation of the second set of configurations and upon expiration of the timer, the UE may switch back to the first set of configurations. In some example, the UE may be configured with a set of timers (e.g., a timer for each set of configurations). If the UE selects or identifies a timer that includes an infinite timer, the UE may initiate configuration set switching based on receiving another DCI 405. That is, the UE may switch back to the first set of configurations based on receiving a third DCI 405.

In some examples, the UE may temporarily deactivate a set of configurations. For example, the UE may receive a DCI 405 activating a set of configurations and sometime after receiving the DCI 405, the UE may receive a second DCI 405 deactivating the set of configurations. In some examples, the set of configurations may be deactivated temporarily. That is, after a duration, the UE may reactivate the set of configurations after receiving the second DCI. In such example, the UE may receive signaling (e.g., RRC signaling or the DCI 405) indicating one or more timers. A timer of the one or more timers may initiate upon deactivation of the first set of configurations and upon expiration of the timer, the UE may reactivate the first set of configurations. In some examples, the UE may be configured with a set of timers (e.g., a timer for each set of configurations).

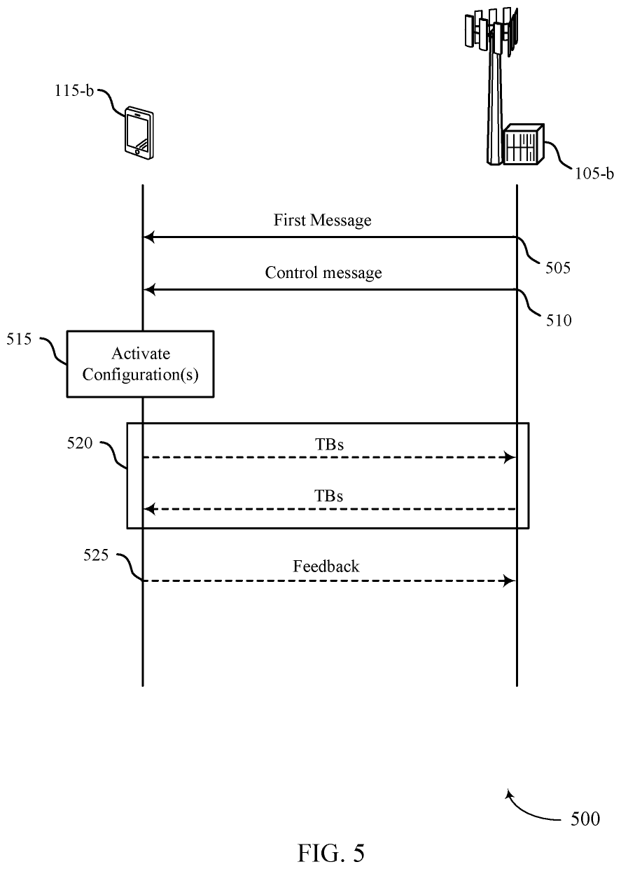

FIG. 5 illustrates an example of a process flow 500 that supports periodic scheduling of multiple unique sets of TBs in accordance with one or more aspects of the present disclosure. In some examples, the process flow 500 may be implemented by aspects of a wireless communications system 100 and a wireless communications system 200. For example, the process flow may include a UE 115-b and a network entity 105-b which may be examples of a UE 115 or a network entity 105 as described with reference to FIGS. 1 and 2. Alternative examples of the following may be implemented, where some steps are performed in a different order than described or are not performed at all. In some cases, steps may include additional features not mentioned below, or further steps may be added.

At 505, the UE 115-b may receive one or more first messages from the network entity 105-b. The one or more first messages may indicate one or more configurations for communications between the network entity 105-b and the UE 115-b during a set of periodic communication occasions. In some examples, each configuration of the set of configurations may indicate a respective periodicity associated with the set of configurations. In some examples, the one or more first messages may be examples RRC signaling. The configurations may refer to SPS configurations (e.g., configurations for downlink communications between the UE 115-b and the network entity 105-b) or CG configurations (e.g., configurations for uplink communications between the UE 115-b and the network entity 105-b). The CG configurations may include Type 1 CG configurations or Type 2 CG configurations.

At 510, the UE 115-b may receive a control message (e.g., an RRC message or a DCI message) from the network entity 105-b. The control message may activate at least one configuration of the one or more configurations for the communications between the UE 115-b and the network entity 105-b. Moreover, the control message may schedule multiple instances of the communications. In some examples, the UE 115-b may identify, based on the control message, that the multiple instances are associated with a same configuration and are scheduled within a same periodic communication occasion associated with the configuration. In another example, the UE 115-b may identify, based on the control message, that each instance of the multiple instances is associated with a respective different configuration of the one or more configurations and each instance is scheduled within a different periodic communication occasion associated with the respective different configurations.

Further, in some examples, the control message may indicate a set of pairs of a SLIV and a corresponding first slot offset value. The SLIV may indicate a starting symbol and a number of consecutive symbols for communicating an instance of the multiple instances. A first slot offset values (e.g., K0 for SPS and K2 for CG) may indicate a number of slots between a slot for receiving the control message and slot for transmitting for communicating the instance of the multiple instances. In some examples, each pair may correspond to an instance of the multiple instances. Additionally, in the case that two or more configurations are activated via the control message, each pair may correspond to a configuration of the two or more configurations. In such example, a number of pairs may be equal to a number of the activated two or more configurations. Alternatively, the number of the activated two or more configurations may be equal to a minimum number of pairs.

In some examples, the UE 115-b may determine a HARQ process ID for each instance of the multiple instances. For example, the UE 115-b may determine HARQ process ID for a first instance of the multiple instances. The UE 115-b may determine the HARQ process ID for the first instance of the multiple instances based on inputting a slot for transmitting the first instance of the multiple instance in an equation. The output of the equation may be the HARQ process ID for the first instance. In one example, the UE 115-b may repeat this process for the remaining instances of the multiple instances. Alternatively, the UE 115-b may determine HARQ process IDs for the remaining instances based on the HARQ process ID for the first instance of the multiple instances. For example, the UE 115-b may increment the HARQ process ID of the first instance by one and a HARQ process ID for a second instances may be equal to the HARQ process ID of the first instance incremented by one.

At 515, the UE 115-b may activate the at least one configuration based on the control message received at 510. In one example, the UE 115-b may activate a single configurations. In another example, the UE 115-b may activate two or more configurations. For example, the UE 115-b may activate a first configuration and a second configuration. In some examples, the at least on configuration may be an example of a CG configuration (e.g., a type 1 CG configuration or a type 2 configuration) or an SPS configuration.

At 520, the UE 115-b may communicate the multiple instances in accordance with the at least one configuration of the one or more configurations. Each instance may include a subset of a set of TBs. Each subset of TBs may be carried in a PUSCH or PDSCH. As such, the UE 115-b may communicate a set of TBs and each subset of TBs of the set may be different from one another. In some examples, each subset of TBs of the set of TB may include resources associated with a same frequency domain or a same MCS. The UE 115-b may determine the location of the subset of TBs (e.g., slot location) using the pair of the SLIV and the corresponding first slot offset value indicated in the control message. In the case of SPS, the UE 115-b may receive the set of TBs to the network entity 105-b. In the case of CG, the UE 115-b may transmit the set of TB to the network entity 105-b. If multiple configurations are activated, the UE 115-b may transmit or receive a first subset of TBs of the set in accordance with the first configuration during a periodic communication occasion associated with the first configurations. Additionally, the UE 115-b may transmit or receive a second subset of TBs of the set in accordance with the second configuration during a periodic communication occasion associated with the second configuration. If a single configuration is activated, the UE 115-b may transmit or receive the first subset of TBs of the set and the second subset of TBs of the set in accordance to the single configuration during a periodic communication occasion associated with the single configuration.

At 525, the UE 115-b may potentially transmit one or more feedback message to the network entity 105-b. The one or more feedback may include feedback information (e.g., HARQ ACK/NACK feedback) for at least one instance of the multiple instances. In one examples, the UE 115-b may transmit feedback message for a first instance of the multiple instances. The UE 115-b may determine a slot for transmitting the feedback message based on a second slot offset value indicated in the control message. In one example, the UE 115-b may additionally transmit a second feedback message for a second instance of the multiple instances to the network entity 105-b based on the second slot offset. Alternatively, the feedback message may also include feedback information for the second instance of the multiple instances.

In some examples, the UE 115-b may switch between different set of configurations. In one example, the control message received at 510 may indicate to activate a first set of configurations. After receiving the control message, the UE 115-b may receive a second control message indicating to activate a second set of configuration. Upon receiving the second control message, the UE 115-b may deactivate the first set of configurations. In some examples, the UE 115-b may switch between sets of configurations based on a timer. For example, the UE 115-b may deactivate the first set of configurations based on an expiration of a timer and activate the second configuration based on the expiration of the timer. In another example, the UE 115-b may temporarily deactivate a set of configurations. For example, the UE 115-b may deactivate the first set of configurations for a duration based on receiving a second control message (e.g., deactivating DCI) and reactivate the first set of configurations based on an expiration of a timer.

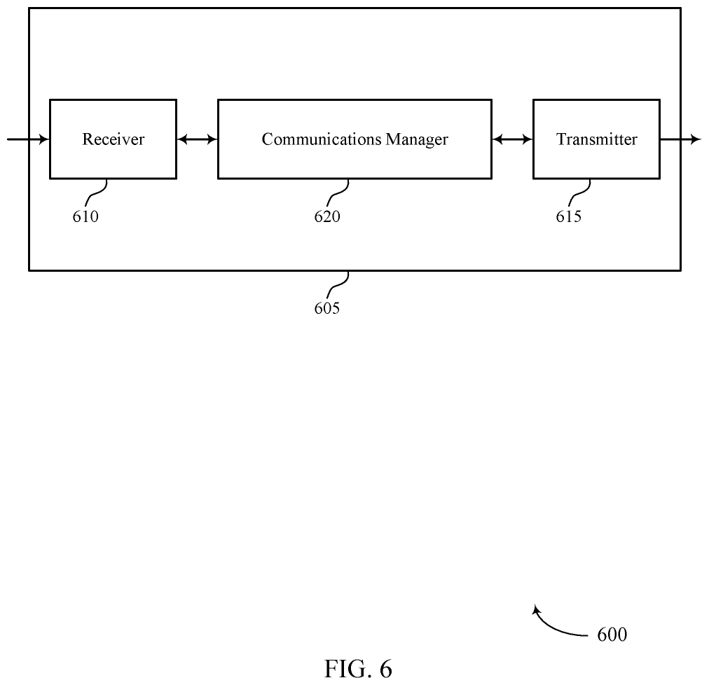

FIG. 6 shows a block diagram 600 of a device 605 that supports periodic scheduling of multiple unique sets of TBs in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to periodic scheduling of multiple unique sets of TBs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to periodic scheduling of multiple unique sets of TBs). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of periodic scheduling of multiple unique sets of TBs as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for receiving one or more first messages that collectively indicate one or more configurations for communications between the UE and a network entity during a set of multiple periodic communication occasions, each configuration of the one or more configurations indicating a respective periodicity associated with the set of multiple periodic communication occasions. The communications manager 620 may be configured as or otherwise support a means for receiving a control message that activates at least one of the one or more configurations for the communications between the UE and the network entity during the set of multiple periodic communication occasions, the control message scheduling multiple instances of the communications. The communications manager 620 may be configured as or otherwise support a means for communicating, based on receiving the control message, the multiple instances in accordance with the at least one of the one or more configurations, each of the multiple instances including a different set of TBs.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for more efficient utilization of communication resources.

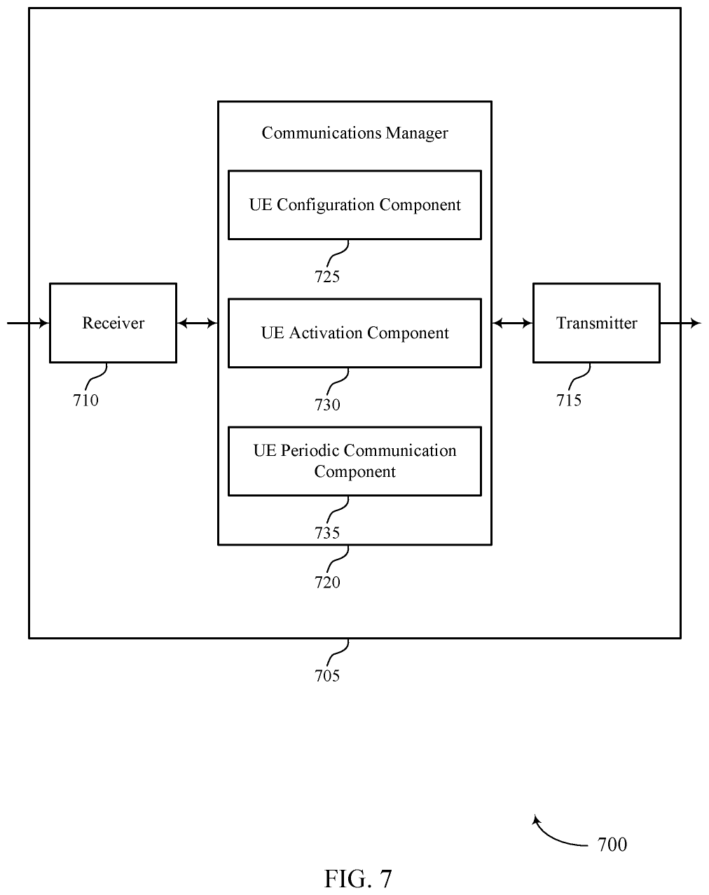

FIG. 7 shows a block diagram 700 of a device 705 that supports periodic scheduling of multiple unique sets of TBs in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to periodic scheduling of multiple unique sets of TBs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to periodic scheduling of multiple unique sets of TBs). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of periodic scheduling of multiple unique sets of TBs as described herein. For example, the communications manager 720 may include a UE configuration component 725, a UE activation component 730, a UE periodic communication component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The UE configuration component 725 may be configured as or otherwise support a means for receiving one or more first messages that collectively indicate one or more configurations for communications between the UE and a network entity during a set of multiple periodic communication occasions, each configuration of the one or more configurations indicating a respective periodicity associated with the set of multiple periodic communication occasions. The UE activation component 730 may be configured as or otherwise support a means for receiving a control message that activates at least one of the one or more configurations for the communications between the UE and the network entity during the set of multiple periodic communication occasions, the control message scheduling multiple instances of the communications. The UE periodic communication component 735 may be configured as or otherwise support a means for communicating, based on receiving the control message, the multiple instances in accordance with the at least one of the one or more configurations, each of the multiple instances including a different set of TBs.

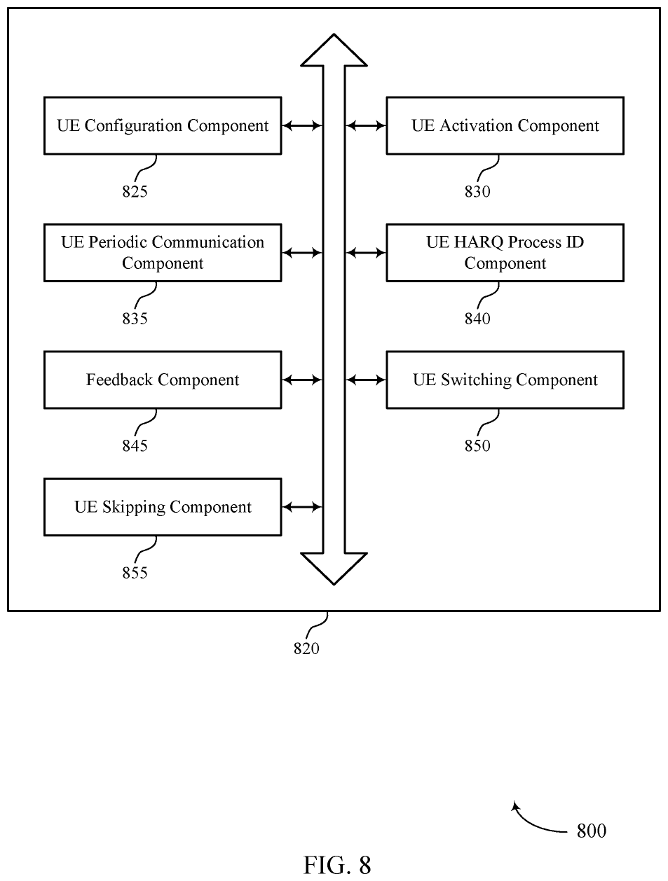

FIG. 8 shows a block diagram 800 of a communications manager 820 that supports periodic scheduling of multiple unique sets of TBs in accordance with one or more aspects of the present disclosure. The communications manager 820 may be an example of aspects of a communications manager 620, a communications manager 720, or both, as described herein. The communications manager 820, or various components thereof, may be an example of means for performing various aspects of periodic scheduling of multiple unique sets of TBs as described herein. For example, the communications manager 820 may include a UE configuration component 825, a UE activation component 830, a UE periodic communication component 835, a UE HARQ process ID component 840, a feedback component 845, a UE switching component 850, a UE skipping component 855, or any combination thereof. Each of these components may communicate, directly or indirectly, with one another (e.g., via one or more buses).

The communications manager 820 may support wireless communication at a UE in accordance with examples as disclosed herein. The UE configuration component 825 may be configured as or otherwise support a means for receiving one or more first messages that collectively indicate one or more configurations for communications between the UE and a network entity during a set of multiple periodic communication occasions, each configuration of the one or more configurations indicating a respective periodicity associated with the set of multiple periodic communication occasions. The UE activation component 830 may be configured as or otherwise support a means for receiving a control message that activates at least one of the one or more configurations for the communications between the UE and the network entity during the set of multiple periodic communication occasions, the control message scheduling multiple instances of the communications. The UE periodic communication component 835 may be configured as or otherwise support a means for communicating, based on receiving the control message, the multiple instances in accordance with the at least one of the one or more configurations, each of the multiple instances including a different set of TBs.

In some examples, to support receiving the control message, the UE activation component 830 may be configured as or otherwise support a means for identifying a schedule for communicating the multiple instances of the communications, where the multiple instances are associated with a same configuration of the one or more configurations and are scheduled within a same periodic communication occasion associated with the same configuration.

In some examples, to support receiving the control message, the UE activation component 830 may be configured as or otherwise support a means for identifying a schedule for communicating the multiple instances of the communications, where the multiple instances are each associated with a respective different configuration of the one or more configurations and are each scheduled within a respective different periodic communication occasion associated with the respective different configuration.

In some examples, to support receiving the control message, the UE activation component 830 may be configured as or otherwise support a means for receiving the control message indicating a set of multiple pairs of a SLIV and a corresponding slot offset value, where each pair of the set of multiple pairs corresponds to an instance of the multiple instances.

In some examples, a slot offset value indicates a number of slots between a slot for receiving the control message and a slot for a periodic communication occasion of the set of multiple periodic communication occasions and a SLIV indicates a starting symbol and a number of consecutive symbols for communicating an instance of the multiple instances.

In some examples, to support communicating the multiple instance, the UE periodic communication component 835 may be configured as or otherwise support a means for communicating an instance of the multiple instances according to a corresponding pair of the set of multiple pairs.

In some examples, a number of pairs corresponding to the set of multiple pairs is equal to a number of configurations corresponding to the at least one configuration.

In some examples, a number of configurations corresponding to the at least one configuration indicates a threshold. In some examples, a number of configurations corresponding to the one or more configuration or a number of pairs corresponding to the set of multiple pairs is equal to or above the threshold.

In some examples, resources for communicating the multiple instances include resources associated with a same frequency domain resource allocation, a same MCS, or both.

In some examples, the UE HARQ process ID component 840 may be configured as or otherwise support a means for determining a HARQ process ID for a first instance of the multiple instances.

In some examples, to support determining the HARQ process ID, the UE HARQ process ID component 840 may be configured as or otherwise support a means for inputting a slot for communicating the first instance of the multiple instances into an algorithm, where an output of the algorithm is the HARQ process ID.

In some examples, the UE HARQ process ID component 840 may be configured as or otherwise support a means for incrementing the HARQ process ID associated with the first instance by one, where a HARQ process ID associated with a second instance of the multiple instances includes the HARQ process ID associated with the first instance by one.

In some examples, the feedback component 845 may be configured as or otherwise support a means for transmitting a second message including feedback information for a first instance of the multiple instances.

In some examples, the feedback component 845 may be configured as or otherwise support a means for determining a slot for transmitting the second message based on a slot offset value, where the slot offset value indicates a number of slots between a slot for communicating the first instance of the multiple instances and a slot for transmitting the second message.

In some examples, the feedback component 845 may be configured as or otherwise support a means for determining, based on the slot offset value, a slot for transmitting a third message including feedback information for a second instance of the multiple instances.

In some examples, the second message further includes feedback information for a second instance of the multiple instances.

In some examples, to support receiving the control message, the UE activation component 830 may be configured as or otherwise support a means for receiving the control message that activates a first configuration and a second configuration of the one or more configurations for communications between the UE and the network entity during the set of multiple periodic communication occasions.

In some examples, to support communicating the multiple instances, the UE periodic communication component 835 may be configured as or otherwise support a means for communicating a first TB in accordance with the first configuration during a periodic communication occasion associated with the first configuration. In some examples, to support communicating the multiple instances, the UE periodic communication component 835 may be configured as or otherwise support a means for communicating a second TB in accordance with the second configuration during a periodic communication occasion associated with the second configuration, where the first TB is different from the second TB.

In some examples, a HARQ process number field included in the control message indicates the first configuration and the second configuration.

In some examples, the UE switching component 850 may be configured as or otherwise support a means for deactivating a third configuration of the one or more configurations for communications between the UE and the network entity during the set of multiple periodic communication occasions based on receiving the control message.

In some examples, the UE switching component 850 may be configured as or otherwise support a means for deactivating the first configuration and the second configuration based on an expiration of a timer. In some examples, the UE switching component 850 may be configured as or otherwise support a means for activating a third configuration for communications between the UE and the network entity during the set of multiple periodic communication occasions based on the expiration of the timer.

In some examples, the UE skipping component 855 may be configured as or otherwise support a means for deactivating the first configuration and the second configuration for a duration based on receiving a second control message. In some examples, the UE skipping component 855 may be configured as or otherwise support a means for activating the first configuration and the second configuration based on expiration of a timer.

In some examples, to support receiving the control message, the UE activation component 830 may be configured as or otherwise support a means for receiving the control message that activates a single configuration of the one or more configurations for communications between the UE and the network entity during the set of multiple periodic communication occasions.

In some examples, to support communicating the multiple instances, the UE periodic communication component 835 may be configured as or otherwise support a means for communicating a first TB and a second TB in accordance with the single configuration during a periodic communication occasion associated with the single configuration, where the first TB is different from the second TB.

In some examples, the control message includes a DCI message.

In some examples, the one or more configurations for communications between the UE and the network entity include at least one CG configuration, at least one SPS configuration, or both.

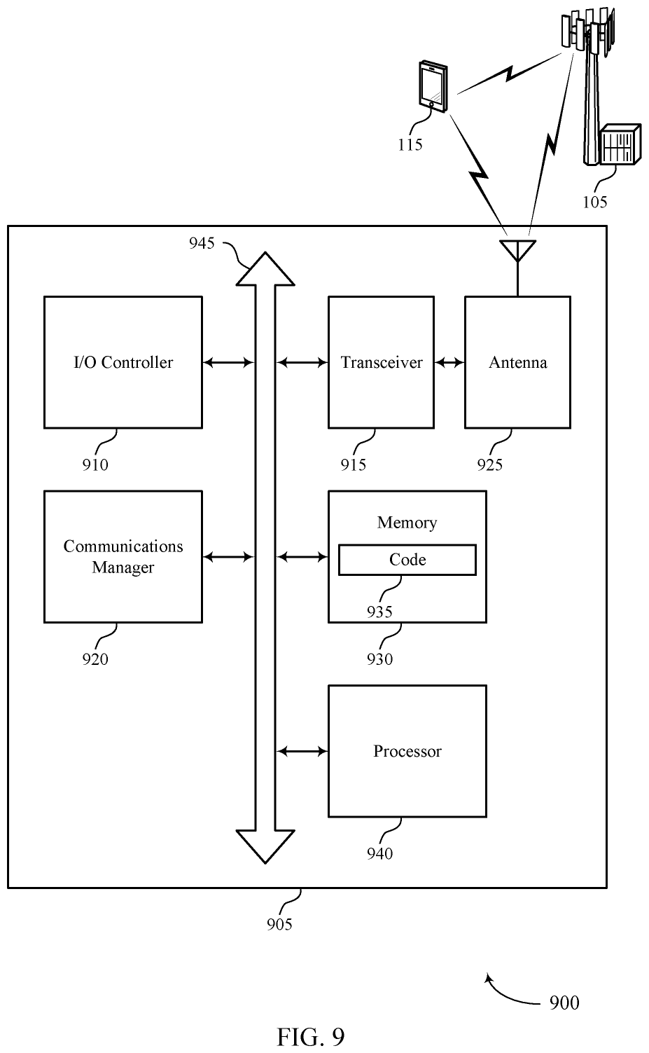

FIG. 9 shows a diagram of a system 900 including a device 905 that supports periodic scheduling of multiple unique sets of TBs in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting periodic scheduling of multiple unique sets of TBs). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving one or more first messages that collectively indicate one or more configurations for communications between the UE and a network entity during a set of multiple periodic communication occasions, each configuration of the one or more configurations indicating a respective periodicity associated with the set of multiple periodic communication occasions. The communications manager 920 may be configured as or otherwise support a means for receiving a control message that activates at least one of the one or more configurations for the communications between the UE and the network entity during the set of multiple periodic communication occasions, the control message scheduling multiple instances of the communications. The communications manager 920 may be configured as or otherwise support a means for communicating, based on receiving the control message, the multiple instances in accordance with the at least one of the one or more configurations, each of the multiple instances including a different set of TBs.

By including or configuring the communications manager 920 in accordance with examples as described herein, the device 905 may support techniques for reduced latency, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of periodic scheduling of multiple unique sets of TBs as described herein, or the processor 940 and the memory 930 may be otherwise configured to perform or support such operations.

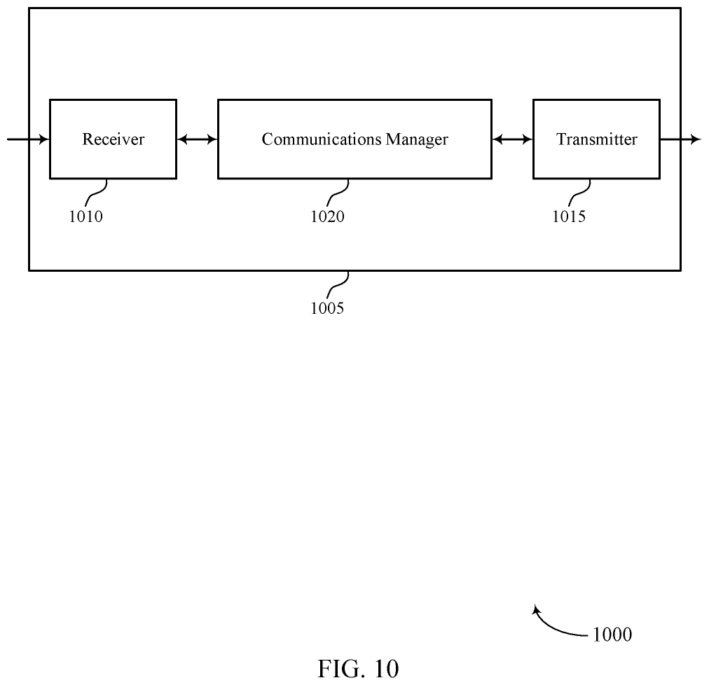

FIG. 10 shows a block diagram 1000 of a device 1005 that supports periodic scheduling of multiple unique sets of TBs in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of periodic scheduling of multiple unique sets of TBs as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for transmitting one or more first messages that collectively indicate one or more configurations for communications between a UE and the network entity during a set of multiple periodic communication occasions, each configuration of the one or more configurations indicating a respective periodicity associated with the set of multiple periodic communication occasions. The communications manager 1020 may be configured as or otherwise support a means for transmitting a control message that activates at least one of the one or more configurations for the communications between the UE and the network entity during the set of multiple periodic communication occasions, the control message scheduling multiple instances of the communications. The communications manager 1020 may be configured as or otherwise support a means for communicating, based on transmitting the control message, the multiple instances in accordance with the at least one of the one or more configurations, each of the multiple instances including a different set of TBs.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for more efficient utilization of communication resources.

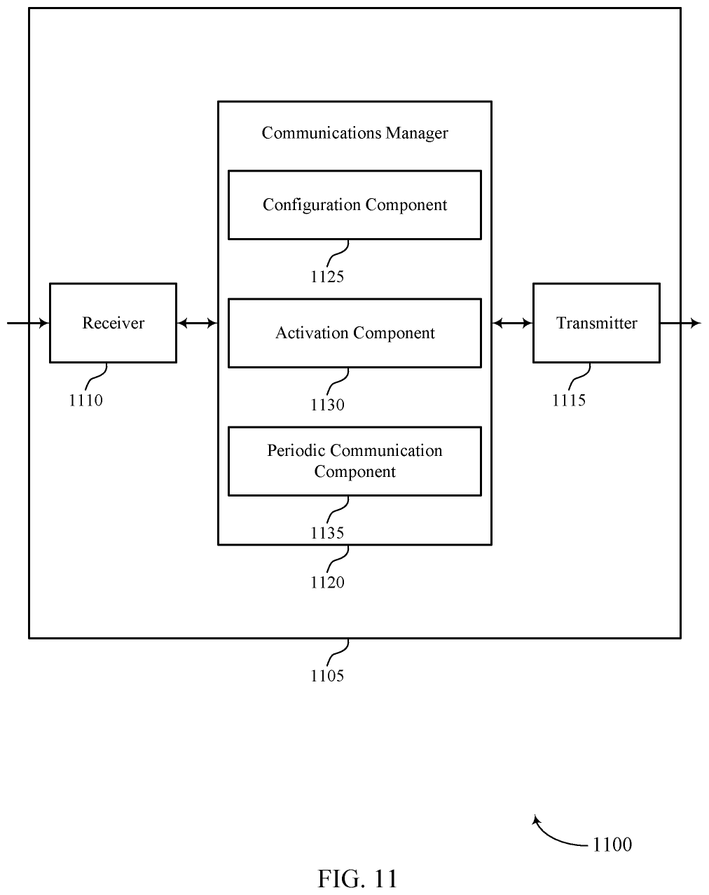

FIG. 11 shows a block diagram 1100 of a device 1105 that supports periodic scheduling of multiple unique sets of TBs in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of periodic scheduling of multiple unique sets of TBs as described herein. For example, the communications manager 1120 may include a configuration component 1125, an activation component 1130, a periodic communication component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The configuration component 1125 may be configured as or otherwise support a means for transmitting one or more first messages that collectively indicate one or more configurations for communications between a UE and the network entity during a set of multiple periodic communication occasions, each configuration of the one or more configurations indicating a respective periodicity associated with the set of multiple periodic communication occasions. The activation component 1130 may be configured as or otherwise support a means for transmitting a control message that activates at least one of the one or more configurations for the communications between the UE and the network entity during the set of multiple periodic communication occasions, the control message scheduling multiple instances of the communications. The periodic communication component 1135 may be configured as or otherwise support a means for communicating, based on transmitting the control message, the multiple instances in accordance with the at least one of the one or more configurations, each of the multiple instances including a different set of TBs.

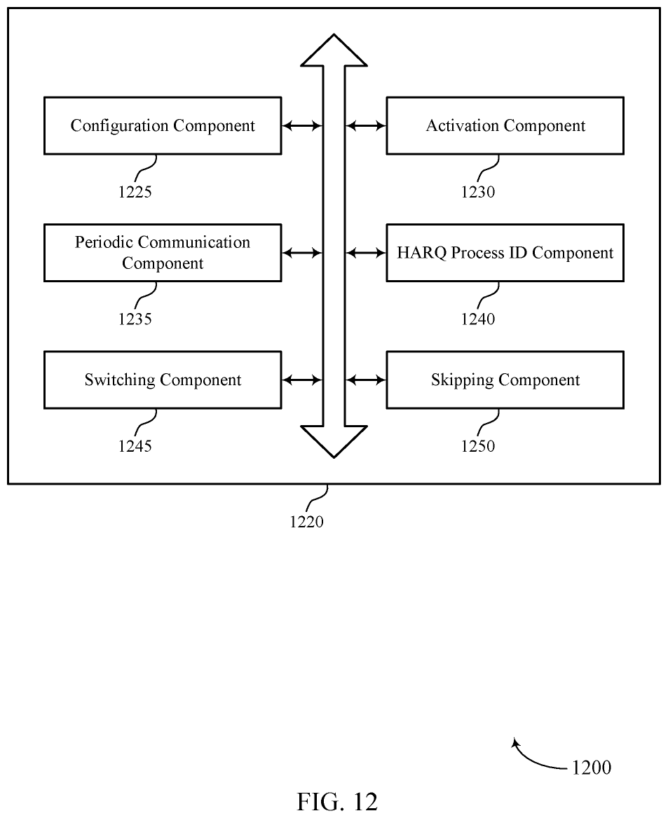

FIG. 12 shows a block diagram 1200 of a communications manager 1220 that supports periodic scheduling of multiple unique sets of TBs in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of periodic scheduling of multiple unique sets of TBs as described herein. For example, the communications manager 1220 may include a configuration component 1225, an activation component 1230, a periodic communication component 1235, an HARQ process ID component 1240, a switching component 1245, a skipping component 1250, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The configuration component 1225 may be configured as or otherwise support a means for transmitting one or more first messages that collectively indicate one or more configurations for communications between a UE and the network entity during a set of multiple periodic communication occasions, each configuration of the one or more configurations indicating a respective periodicity associated with the set of multiple periodic communication occasions. The activation component 1230 may be configured as or otherwise support a means for transmitting a control message that activates at least one of the one or more configurations for the communications between the UE and the network entity during the set of multiple periodic communication occasions, the control message scheduling multiple instances of the communications. The periodic communication component 1235 may be configured as or otherwise support a means for communicating, based on transmitting the control message, the multiple instances in accordance with the at least one of the one or more configurations, each of the multiple instances including a different set of TBs.

In some examples, to support transmitting the control message, the activation component 1230 may be configured as or otherwise support a means for transmitting a schedule for communicating the multiple instances of the communications, where the multiple instances are associated with a same configuration of the one or more configurations and are scheduled within a same periodic communication occasion associated with the same configuration.

In some examples, to support transmitting the control message, the activation component 1230 may be configured as or otherwise support a means for transmitting a schedule for communicating the multiple instances of the communications, where the multiple instances are each associated with a respective different configuration of the one or more configurations and are each scheduled within a respective different periodic communication occasion associated with the respective different configuration.

In some examples, to support transmitting the control message, the activation component 1230 may be configured as or otherwise support a means for transmitting the control message indicating a set of multiple pairs of a SLIV and a corresponding slot offset value, where each pair of the set of multiple pairs corresponds to an instance of the multiple instances.

In some examples, a slot offset value indicates a number of slots between a slot for receiving the control message and a slot for a periodic communication occasion of the set of multiple periodic communication occasions and a SLIV indicates a starting symbol and a number of consecutive symbols for communicating an instance of the multiple instances.

In some examples, to support communicating the multiple instance, the periodic communication component 1235 may be configured as or otherwise support a means for communicating an instance of the multiple instances according to a corresponding pair of the set of multiple pairs.

In some examples, a number of pairs corresponding to the set of multiple pairs is equal to a number of configurations corresponding to the at least one configuration.

In some examples, a number of configurations corresponding to the at least one configuration indicates a threshold. In some examples, a number of configurations corresponding to the one or more configuration or a number of pairs corresponding to the set of multiple pairs is equal to or above the threshold.

In some examples, resources for communicating the multiple instances include resources associated with a same frequency domain resource allocation, a same MCS, or both.

In some examples, the HARQ process ID component 1240 may be configured as or otherwise support a means for determining a HARQ process ID for a first instance of the multiple instances.

In some examples, to support determining the HARQ process ID, the HARQ process ID component 1240 may be configured as or otherwise support a means for inputting a slot for communicating the first instance of the multiple instances into an algorithm, where an output of the algorithm is the HARQ process ID.

In some examples, the HARQ process ID component 1240 may be configured as or otherwise support a means for incrementing the HARQ process ID associated with the first instance by one, where a HARQ process ID associated with a second instance of the multiple instances includes the HARQ process ID associated with the first instance by one.

In some examples, to support transmitting the control message, the activation component 1230 may be configured as or otherwise support a means for transmitting the control message that activates a first configuration and a second configuration of the one or more configurations for communications between the UE and the network entity during the set of multiple periodic communication occasions.

In some examples, to support communicating the multiple instances, the periodic communication component 1235 may be configured as or otherwise support a means for communicating a first TB in accordance with the first configuration during a periodic communication occasion associated with the first configuration. In some examples, to support communicating the multiple instances, the periodic communication component 1235 may be configured as or otherwise support a means for communicating a second TB in accordance with the second configuration during a periodic communication occasion associated with the second configuration, where the first TB is different from the second TB.

In some examples, a HARQ process number field included in the control message indicates the first configuration and the second configuration.

In some examples, the switching component 1245 may be configured as or otherwise support a means for deactivating a third configuration of the one or more configurations for communications between the UE and the network entity during the set of multiple periodic communication occasions based on transmitting the control message.

In some examples, the switching component 1245 may be configured as or otherwise support a means for deactivating the first configuration and the second configuration based on an expiration of a timer. In some examples, the switching component 1245 may be configured as or otherwise support a means for activating a third configuration for communications between the UE and the network entity during the set of multiple periodic communication occasions based on the expiration of the timer.

In some examples, the skipping component 1250 may be configured as or otherwise support a means for deactivating the first configuration and the second configuration for a duration based on transmitting a second control message. In some examples, the skipping component 1250 may be configured as or otherwise support a means for activating the first configuration and the second configuration based on expiration of a timer.

In some examples, to support transmitting the control message, the activation component 1230 may be configured as or otherwise support a means for transmitting the control message that activates a single configuration of the one or more configurations for communications between the UE and the network entity during the set of multiple periodic communication occasions.

In some examples, to support communicating the multiple instances, the periodic communication component 1235 may be configured as or otherwise support a means for communicating a first TB and a second TB in accordance with the single configuration during a periodic communication occasion associated with the single configuration, where the first TB is different from the second TB.

In some examples, the control message includes a DCI message.

In some examples, the one or more configurations for communications between the UE and the network entity include at least one CG configuration, at least one SPS configuration, or both.

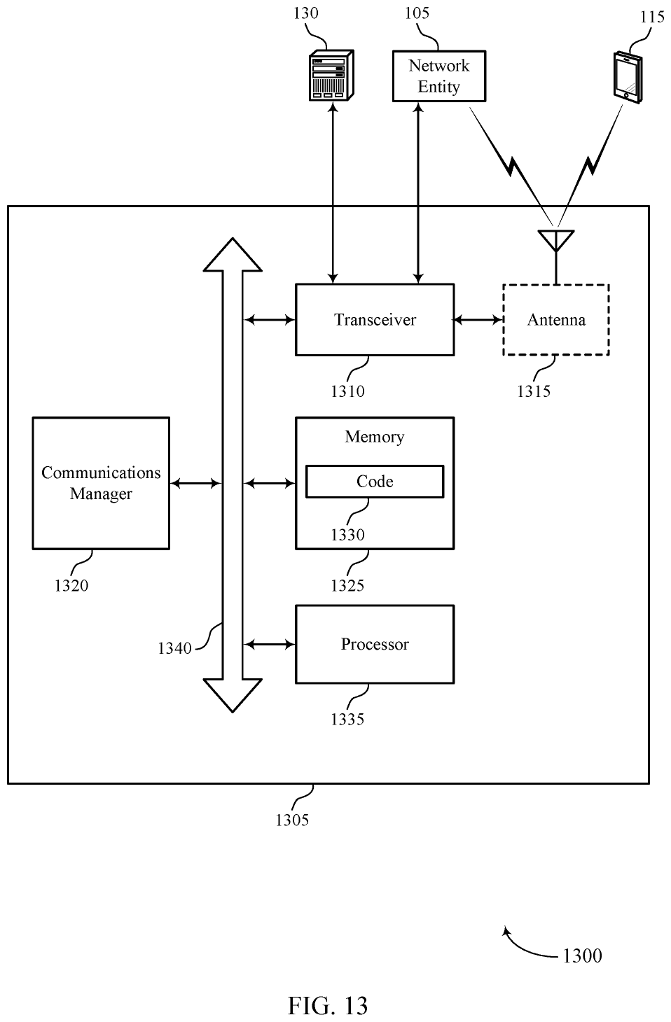

FIG. 13 shows a diagram of a system 1300 including a device 1305 that supports periodic scheduling of multiple unique sets of TBs in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting periodic scheduling of multiple unique sets of TBs). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for transmitting one or more first messages that collectively indicate one or more configurations for communications between a UE and the network entity during a set of multiple periodic communication occasions, each configuration of the one or more configurations indicating a respective periodicity associated with the set of multiple periodic communication occasions. The communications manager 1320 may be configured as or otherwise support a means for transmitting a control message that activates at least one of the one or more configurations for the communications between the UE and the network entity during the set of multiple periodic communication occasions, the control message scheduling multiple instances of the communications. The communications manager 1320 may be configured as or otherwise support a means for communicating, based on transmitting the control message, the multiple instances in accordance with the at least one of the one or more configurations, each of the multiple instances including a different set of TBs.

By including or configuring the communications manager 1320 in accordance with examples as described herein, the device 1305 may support techniques for reduced latency, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of periodic scheduling of multiple unique sets of TBs as described herein, or the processor 1335 and the memory 1325 may be otherwise configured to perform or support such operations.

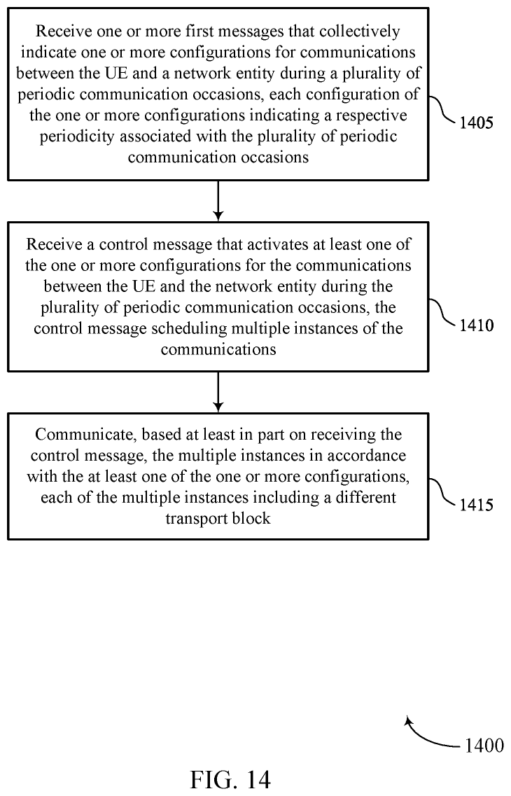

FIG. 14 shows a flowchart illustrating a method 1400 that supports periodic scheduling of multiple unique sets of TBs in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving one or more first messages that collectively indicate one or more configurations for communications between the UE and a network entity during a set of multiple periodic communication occasions, each configuration of the one or more configurations indicating a respective periodicity associated with the set of multiple periodic communication occasions. The operations of 1405 may be performed in accordance with examples as disclosed herein. In some examples, aspects of the operations of 1405 may be performed by a UE configuration component 825 as described with reference to FIG. 8.

At 1410, the method may include receiving a control message that activates at least one of the one or more configurations for the communications between the UE and the network entity during the set of multiple periodic communication occasions, the control message scheduling multiple instances of the communications. The operations of 1410 may be performed in accordance with examples as disclosed herein. In some examples, aspects of the operations of 1410 may be performed by a UE activation component 830 as described with reference to FIG. 8.

At 1415, the method may include communicating, based on receiving the control message, the multiple instances in accordance with the at least one of the one or more configurations, each of the multiple instances including a different set of TBs. The operations of 1415 may be performed in accordance with examples as disclosed herein. In some examples, aspects of the operations of 1415 may be performed by a UE periodic communication component 835 as described with reference to FIG. 8.

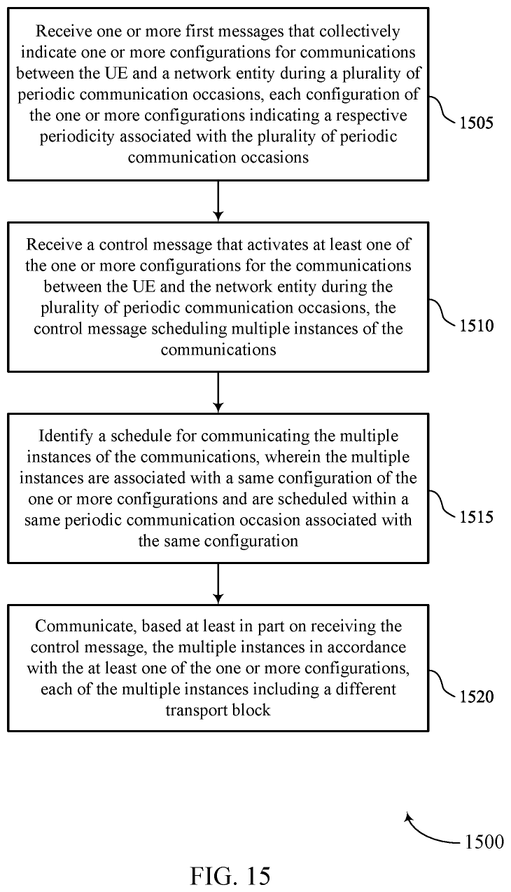

FIG. 15 shows a flowchart illustrating a method 1500 that supports periodic scheduling of multiple unique sets of TBs in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving one or more first messages that collectively indicate one or more configurations for communications between the UE and a network entity during a set of multiple periodic communication occasions, each configuration of the one or more configurations indicating a respective periodicity associated with the set of multiple periodic communication occasions. The operations of 1505 may be performed in accordance with examples as disclosed herein. In some examples, aspects of the operations of 1505 may be performed by a UE configuration component 825 as described with reference to FIG. 8.

At 1510, the method may include receiving a control message that activates at least one of the one or more configurations for the communications between the UE and the network entity during the set of multiple periodic communication occasions, the control message scheduling multiple instances of the communications. The operations of 1510 may be performed in accordance with examples as disclosed herein. In some examples, aspects of the operations of 1510 may be performed by a UE activation component 830 as described with reference to FIG. 8.

At 1515, the method may include identifying a schedule for communicating the multiple instances of the communications, where the multiple instances are associated with a same configuration of the one or more configurations and are scheduled within a same periodic communication occasion associated with the same configuration. The operations of 1515 may be performed in accordance with examples as disclosed herein. In some examples, aspects of the operations of 1515 may be performed by a UE activation component 830 as described with reference to FIG. 8.

At 1520, the method may include communicating, based on receiving the control message, the multiple instances in accordance with the at least one of the one or more configurations, each of the multiple instances including a different set of TBs. The operations of 1520 may be performed in accordance with examples as disclosed herein. In some examples, aspects of the operations of 1520 may be performed by a UE periodic communication component 835 as described with reference to FIG. 8.

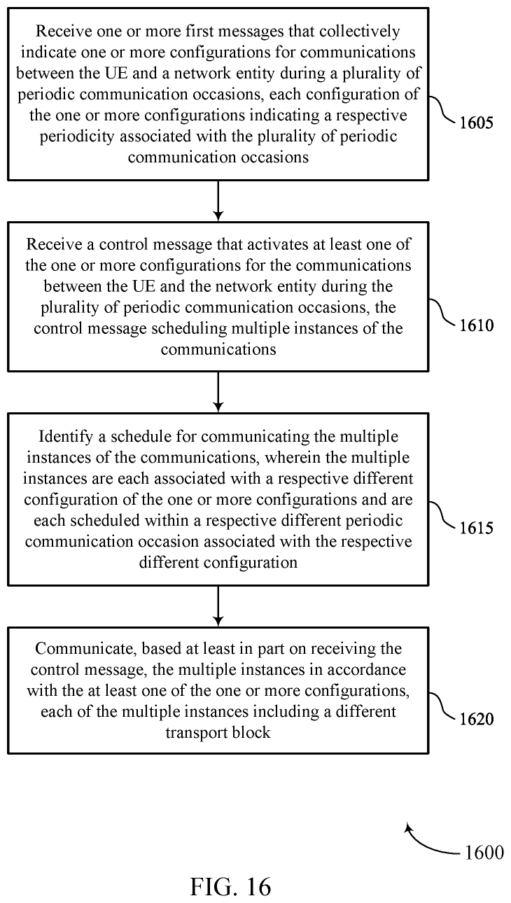

FIG. 16 shows a flowchart illustrating a method 1600 that supports periodic scheduling of multiple unique sets of TBs in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving one or more first messages that collectively indicate one or more configurations for communications between the UE and a network entity during a set of multiple periodic communication occasions, each configuration of the one or more configurations indicating a respective periodicity associated with the set of multiple periodic communication occasions. The operations of 1605 may be performed in accordance with examples as disclosed herein. In some examples, aspects of the operations of 1605 may be performed by a UE configuration component 825 as described with reference to FIG. 8.

At 1610, the method may include receiving a control message that activates at least one of the one or more configurations for the communications between the UE and the network entity during the set of multiple periodic communication occasions, the control message scheduling multiple instances of the communications. The operations of 1610 may be performed in accordance with examples as disclosed herein. In some examples, aspects of the operations of 1610 may be performed by a UE activation component 830 as described with reference to FIG. 8.

At 1615, the method may include identifying a schedule for communicating the multiple instances of the communications, where the multiple instances are each associated with a respective different configuration of the one or more configurations and are each scheduled within a respective different periodic communication occasion associated with the respective different configuration. The operations of 1615 may be performed in accordance with examples as disclosed herein. In some examples, aspects of the operations of 1615 may be performed by a UE activation component 830 as described with reference to FIG. 8.

At 1620, the method may include communicating, based on receiving the control message, the multiple instances in accordance with the at least one of the one or more configurations, each of the multiple instances including a different set of TBs. The operations of 1620 may be performed in accordance with examples as disclosed herein. In some examples, aspects of the operations of 1620 may be performed by a UE periodic communication component 835 as described with reference to FIG. 8.

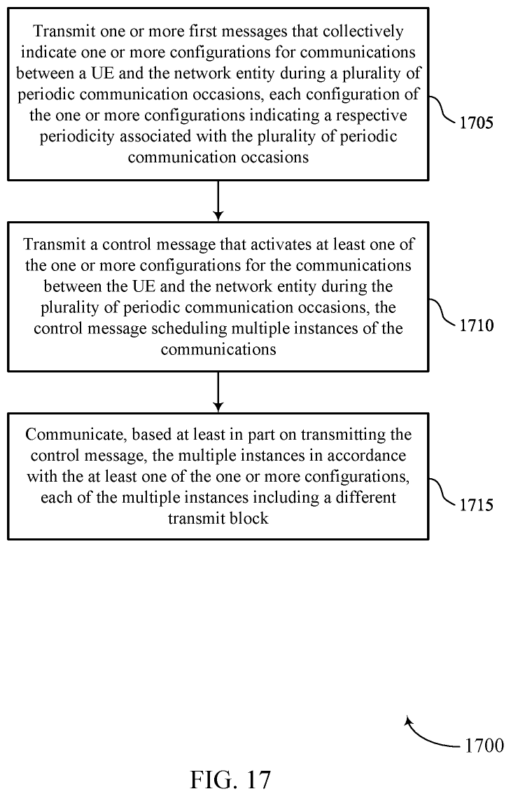

FIG. 17 shows a flowchart illustrating a method 1700 that supports periodic scheduling of multiple unique sets of TBs in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting one or more first messages that collectively indicate one or more configurations for communications between a UE and the network entity during a set of multiple periodic communication occasions, each configuration of the one or more configurations indicating a respective periodicity associated with the set of multiple periodic communication occasions. The operations of 1705 may be performed in accordance with examples as disclosed herein. In some examples, aspects of the operations of 1705 may be performed by a configuration component 1225 as described with reference to FIG. 12.

At 1710, the method may include transmitting a control message that activates at least one of the one or more configurations for the communications between the UE and the network entity during the set of multiple periodic communication occasions, the control message scheduling multiple instances of the communications. The operations of 1710 may be performed in accordance with examples as disclosed herein. In some examples, aspects of the operations of 1710 may be performed by an activation component 1230 as described with reference to FIG. 12.

At 1715, the method may include communicating, based on transmitting the control message, the multiple instances in accordance with the at least one of the one or more configurations, each of the multiple instances including a different set of TBs. The operations of 1715 may be performed in accordance with examples as disclosed herein. In some examples, aspects of the operations of 1715 may be performed by a periodic communication component 1235 as described with reference to FIG. 12.

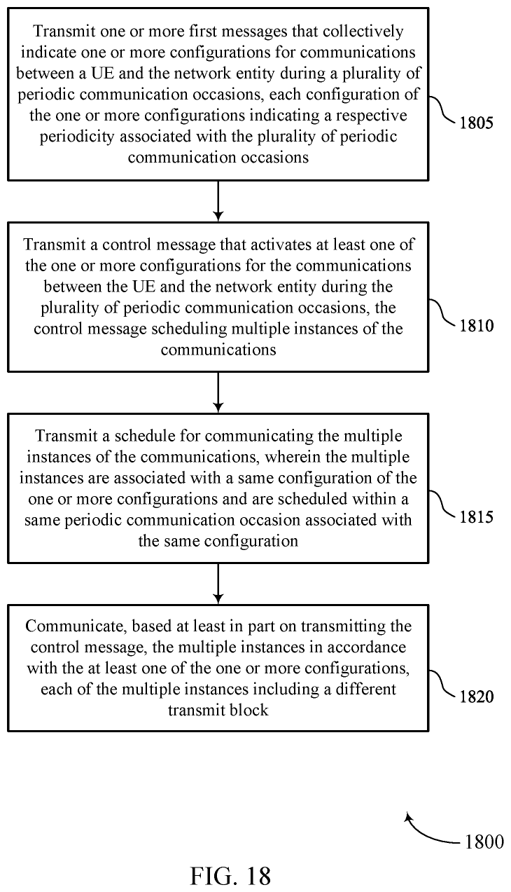

FIG. 18 shows a flowchart illustrating a method 1800 that supports periodic scheduling of multiple unique sets of TBs in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include transmitting one or more first messages that collectively indicate one or more configurations for communications between a UE and the network entity during a set of multiple periodic communication occasions, each configuration of the one or more configurations indicating a respective periodicity associated with the set of multiple periodic communication occasions. The operations of 1805 may be performed in accordance with examples as disclosed herein. In some examples, aspects of the operations of 1805 may be performed by a configuration component 1225 as described with reference to FIG. 12.

At 1810, the method may include transmitting a control message that activates at least one of the one or more configurations for the communications between the UE and the network entity during the set of multiple periodic communication occasions, the control message scheduling multiple instances of the communications. The operations of 1810 may be performed in accordance with examples as disclosed herein. In some examples, aspects of the operations of 1810 may be performed by an activation component 1230 as described with reference to FIG. 12.

At 1815, the method may include transmitting a schedule for communicating the multiple instances of the communications, where the multiple instances are associated with a same configuration of the one or more configurations and are scheduled within a same periodic communication occasion associated with the same configuration. The operations of 1815 may be performed in accordance with examples as disclosed herein. In some examples, aspects of the operations of 1815 may be performed by an activation component 1230 as described with reference to FIG. 12.

At 1820, the method may include communicating, based on transmitting the control message, the multiple instances in accordance with the at least one of the one or more configurations, each of the multiple instances including a different set of TBs. The operations of 1820 may be performed in accordance with examples as disclosed herein. In some examples, aspects of the operations of 1820 may be performed by a periodic communication component 1235 as described with reference to FIG. 12.

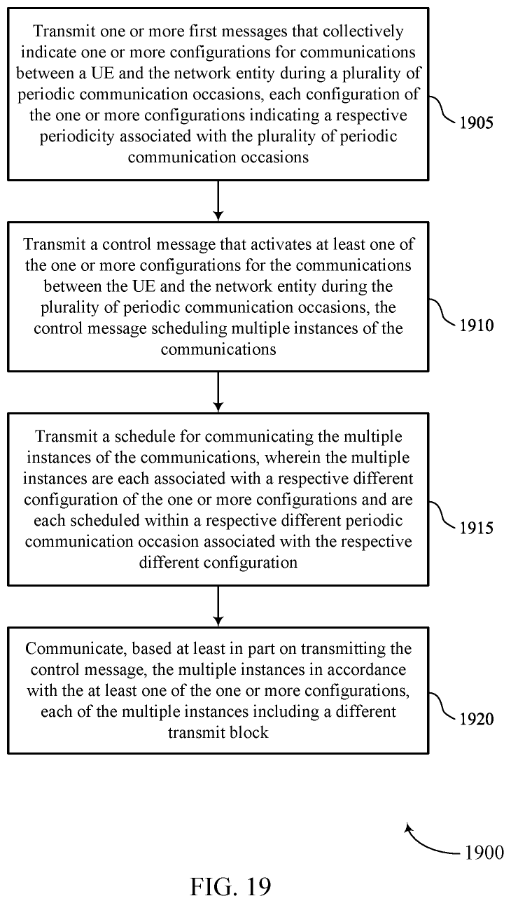

FIG. 19 shows a flowchart illustrating a method 1900 that supports periodic scheduling of multiple unique sets of TBs in accordance with one or more aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include transmitting one or more first messages that collectively indicate one or more configurations for communications between a UE and the network entity during a set of multiple periodic communication occasions, each configuration of the one or more configurations indicating a respective periodicity associated with the set of multiple periodic communication occasions. The operations of 1905 may be performed in accordance with examples as disclosed herein. In some examples, aspects of the operations of 1905 may be performed by a configuration component 1225 as described with reference to FIG. 12.

At 1910, the method may include transmitting a control message that activates at least one of the one or more configurations for the communications between the UE and the network entity during the set of multiple periodic communication occasions, the control message scheduling multiple instances of the communications. The operations of 1910 may be performed in accordance with examples as disclosed herein. In some examples, aspects of the operations of 1910 may be performed by an activation component 1230 as described with reference to FIG. 12.

At 1915, the method may include transmitting a schedule for communicating the multiple instances of the communications, where the multiple instances are each associated with a respective different configuration of the one or more configurations and are each scheduled within a respective different periodic communication occasion associated with the respective different configuration. The operations of 1915 may be performed in accordance with examples as disclosed herein. In some examples, aspects of the operations of 1915 may be performed by an activation component 1230 as described with reference to FIG. 12.

At 1920, the method may include communicating, based on transmitting the control message, the multiple instances in accordance with the at least one of the one or more configurations, each of the multiple instances including a different set of TB. The operations of 1920 may be performed in accordance with examples as disclosed herein. In some examples, aspects of the operations of 1920 may be performed by a periodic communication component 1235 as described with reference to FIG. 12.

The following provides an overview of aspects of the present disclosure:

Aspect 1: A method for wireless communication at a UE, comprising: receiving one or more first messages that collectively indicate one or more configurations for communications between the UE and a network entity during a plurality of periodic communication occasions, each configuration of the one or more configurations indicating a respective periodicity associated with the plurality of periodic communication occasions; receiving a control message that activates at least one of the one or more configurations for the communications between the UE and the network entity during the plurality of periodic communication occasions, the control message scheduling multiple instances of the communications; and communicating, based at least in part on receiving the control message, the multiple instances in accordance with the at least one of the one or more configurations, each of the multiple instances including a different set of TBs.

Aspect 2: The method of aspect 1, wherein receiving the control message further comprises: identifying a schedule for communicating the multiple instances of the communications, wherein the multiple instances are associated with a same configuration of the one or more configurations and are scheduled within a same periodic communication occasion associated with the same configuration.

Aspect 3: The method of aspect 1, wherein receiving the control message further comprises: identifying a schedule for communicating the multiple instances of the communications, wherein the multiple instances are each associated with a respective different configuration of the one or more configurations and are each scheduled within a respective different periodic communication occasion associated with the respective different configuration.

Aspect 4: The method of any of aspects 1 through 3, wherein receiving the control message comprises: receiving the control message indicating a plurality of pairs of a SLIV and a corresponding slot offset value, wherein each pair of the plurality of pairs corresponds to an instance of the multiple instances.

Aspect 5: The method of aspect 4, wherein a slot offset value indicates a number of slots between a slot for receiving the control message and a slot for a periodic communication occasion of the plurality of periodic communication occasions and a SLIV indicates a starting symbol and a number of consecutive symbols for communicating an instance of the multiple instances.

Aspect 6: The method of any of aspects 4 through 5, wherein communicating the multiple instance comprises: communicating an instance of the multiple instances according to a corresponding pair of the plurality of pairs.

Aspect 7: The method of any of aspects 4 through 6, wherein a number of pairs corresponding to the plurality of pairs is equal to a number of configurations corresponding to the at least one configuration.

Aspect 8: The method of any of aspects 4 through 7, wherein a number of configurations corresponding to the at least one configuration indicates a threshold, and a number of configurations corresponding to the one or more configuration or a number of pairs corresponding to the plurality of pairs is equal to or above the threshold.

Aspect 9: The method of any of aspects 1 through 8, wherein resources for communicating the multiple instances comprise resources associated with a same FDRA, a same MCS, or both.

Aspect 10: The method of any of aspects 1 through 9, further comprising: determining a HARQ process ID for a first instance of the multiple instances.

Aspect 11: The method of aspect 10, wherein determining the HARQ process ID comprises: inputting a slot for communicating the first instance of the multiple instances into an algorithm, wherein an output of the algorithm is the HARQ process ID.

Aspect 12: The method of aspect 11, further comprising: incrementing the HARQ process ID associated with the first instance by one, wherein a HARQ process ID associated with a second instance of the multiple instances comprises the HARQ process ID associated with the first instance by one.

Aspect 13: The method of any of aspects 1 through 12, further comprising: transmitting a second message comprising feedback information for a first instance of the multiple instances.

Aspect 14: The method of aspect 13, further comprising: determining a slot for transmitting the second message based at least in part on a slot offset value, wherein the slot offset value indicates a number of slots between a slot for communicating the first instance of the multiple instances and a slot for transmitting the second message.

Aspect 15: The method of aspect 14, further comprising: determining, based at least in part on the slot offset value, a slot for transmitting a third message comprising feedback information for a second instance of the multiple instances.

Aspect 16: The method of any of aspects 14 through 15, wherein the second message further comprises feedback information for a second instance of the multiple instances.

Aspect 17: The method of any of aspects 1 through 16, wherein receiving the control message further comprises: receiving the control message that activates a first configuration and a second configuration of the one or more configurations for communications between the UE and the network entity during the plurality of periodic communication occasions.

Aspect 18: The method of aspect 17, wherein communicating the multiple instances comprises: communicating a first set of TBs in accordance with the first configuration during a periodic communication occasion associated with the first configuration; and communicating a second set of TBs in accordance with the second configuration during a periodic communication occasion associated with the second configuration, wherein the first set of TBs is different from the second set of TBs.

Aspect 19: The method of any of aspects 17 through 18, wherein a HARQ process number field included in the control message indicates the first configuration and the second configuration.

Aspect 20: The method of any of aspects 17 through 19, further comprising: deactivating a third configuration of the one or more configurations for communications between the UE and the network entity during the plurality of periodic communication occasions based at least in part on receiving the control message.

Aspect 21: The method of any of aspects 17 through 20, further comprising: deactivating the first configuration and the second configuration based at least in part on an expiration of a timer; and activating a third configuration for communications between the UE and the network entity during the plurality of periodic communication occasions based at least in part on the expiration of the timer.

Aspect 22: The method of any of aspects 17 through 21, further comprising: deactivating the first configuration and the second configuration for a duration based at least in part on receiving a second control message; and activating the first configuration and the second configuration based at least in part on expiration of a timer.

Aspect 23: The method of any of aspects 1 through 22, wherein receiving the control message further comprises: receiving the control message that activates a single configuration of the one or more configurations for communications between the UE and the network entity during the plurality of periodic communication occasions.

Aspect 24: The method of aspect 23, wherein communicating the multiple instances comprises: communicating a first set of TBs and a second set of TBs in accordance with the single configuration during a periodic communication occasion associated with the single configuration, wherein the first set of TBs is different from the second set of TBs.

Aspect 25: The method of any of aspects 1 through 24, wherein the control message comprises a DCI message.

Aspect 26: The method of any of aspects 1 through 25, wherein the one or more configurations for communications between the UE and the network entity include at least one CG configuration, at least one SPS configuration, or both.

Aspect 27: A method for wireless communication at a network entity, comprising: transmitting one or more first messages that collectively indicate one or more configurations for communications between a UE and the network entity during a plurality of periodic communication occasions, each configuration of the one or more configurations indicating a respective periodicity associated with the plurality of periodic communication occasions; transmitting a control message that activates at least one of the one or more configurations for the communications between the UE and the network entity during the plurality of periodic communication occasions, the control message scheduling multiple instances of the communications; and communicating, based at least in part on transmitting the control message, the multiple instances in accordance with the at least one of the one or more configurations, each of the multiple instances including a different set of TBs.

Aspect 28: The method of aspect 27, wherein transmitting the control message further comprises: transmitting a schedule for communicating the multiple instances of the communications, wherein the multiple instances are associated with a same configuration of the one or more configurations and are scheduled within a same periodic communication occasion associated with the same configuration.

Aspect 29: The method of aspect 27, wherein transmitting the control message further comprises: transmitting a schedule for communicating the multiple instances of the communications, wherein the multiple instances are each associated with a respective different configuration of the one or more configurations and are each scheduled within a respective different periodic communication occasion associated with the respective different configuration.

Aspect 30: The method of any of aspects 27 through 29, wherein transmitting the control message comprises: transmitting the control message indicating a plurality of pairs of a SLIV and a corresponding slot offset value, wherein each pair of the plurality of pairs corresponds to an instance of the multiple instances.

Aspect 31: The method of aspect 30, wherein a slot offset value indicates a number of slots between a slot for receiving the control message and a slot for a periodic communication occasion of the plurality of periodic communication occasions and a SLIV indicates a starting symbol and a number of consecutive symbols for communicating an instance of the multiple instances.

Aspect 32: The method of any of aspects 30 through 31, wherein communicating the multiple instance comprises: communicating an instance of the multiple instances according to a corresponding pair of the plurality of pairs.

Aspect 33: The method of any of aspects 30 through 32, wherein a number of pairs corresponding to the plurality of pairs is equal to a number of configurations corresponding to the at least one configuration.

Aspect 34: The method of any of aspects 30 through 33, wherein a number of configurations corresponding to the at least one configuration indicates a threshold, and a number of configurations corresponding to the one or more configuration or a number of pairs corresponding to the plurality of pairs is equal to or above the threshold.

Aspect 35: The method of any of aspects 27 through 34, wherein resources for communicating the multiple instances comprise resources associated with a same FDRA, a same MCS, or both.

Aspect 36: The method of any of aspects 27 through 35, further comprising: determining a HARQ process ID for a first instance of the multiple instances.

Aspect 37: The method of aspect 36, wherein determining the HARQ process ID comprises: inputting a slot for communicating the first instance of the multiple instances into an algorithm, wherein an output of the algorithm is the HARQ process ID.

Aspect 38: The method of aspect 37, further comprising: incrementing the HARQ process ID associated with the first instance by one, wherein a HARQ process ID associated with a second instance of the multiple instances comprises the HARQ process ID associated with the first instance by one.

Aspect 39: The method of any of aspects 27 through 38, wherein transmitting the control message further comprises: transmitting the control message that activates a first configuration and a second configuration of the one or more configurations for communications between the UE and the network entity during the plurality of periodic communication occasions.

Aspect 40: The method of aspect 39, wherein communicating the multiple instances comprises: communicating a first set of TBs in accordance with the first configuration during a periodic communication occasion associated with the first configuration; and communicating a second set of TBs in accordance with the second configuration during a periodic communication occasion associated with the second configuration, wherein the first set of TBs is different from the second set of TBs.

Aspect 41: The method of any of aspects 39 through 40, wherein a HARQ process number field included in the control message indicates the first configuration and the second configuration.

Aspect 42: The method of any of aspects 39 through 41, further comprising: deactivating a third configuration of the one or more configurations for communications between the UE and the network entity during the plurality of periodic communication occasions based at least in part on transmitting the control message.

Aspect 43: The method of any of aspects 39 through 42, further comprising: deactivating the first configuration and the second configuration based at least in part on an expiration of a timer; and activating a third configuration for communications between the UE and the network entity during the plurality of periodic communication occasions based at least in part on the expiration of the timer.

Aspect 44: The method of any of aspects 39 through 43, further comprising: deactivating the first configuration and the second configuration for a duration based at least in part on transmitting a second control message; and activating the first configuration and the second configuration based at least in part on expiration of a timer.

Aspect 45: The method of any of aspects 27 through 44, wherein transmitting the control message further comprises: transmitting the control message that activates a single configuration of the one or more configurations for communications between the UE and the network entity during the plurality of periodic communication occasions.

Aspect 46: The method of aspect 45, wherein communicating the multiple instances comprises: communicating a first set of TBs and a second set of TBs in accordance with the single configuration during a periodic communication occasion associated with the single configuration, wherein the first set of TBs is different from the second set of TBs.

Aspect 47: The method of any of aspects 27 through 46, wherein the control message comprises a DCI message.

Aspect 48: The method of any of aspects 27 through 47, wherein the one or more configurations for communications between the UE and the network entity include at least one CG configuration, at least one SPS configuration, or both.

Aspect 49: An apparatus for wireless communication at a UE, comprising a processor; memory coupled with the processor; and instructions stored in the memory and executable by the processor to cause the apparatus to perform a method of any of aspects 1 through 26.

Aspect 50: An apparatus for wireless communication at a UE, comprising at least one means for performing a method of any of aspects 1 through 26.

Aspect 51: A non-transitory computer-readable medium storing code for wireless communication at a UE, the code comprising instructions executable by a processor to perform a method of any of aspects 1 through 26.

Aspect 52: An apparatus for wireless communication at a network entity, comprising a processor; memory coupled with the processor; and instructions stored in the memory and executable by the processor to cause the apparatus to perform a method of any of aspects 27 through 48.

Aspect 53: An apparatus for wireless communication at a network entity, comprising at least one means for performing a method of any of aspects 27 through 48.

Aspect 54: A non-transitory computer-readable medium storing code for wireless communication at a network entity, the code comprising instructions executable by a processor to perform a method of any of aspects 27 through 48.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
a processor;
memory coupled with the processor; and
instructions stored in the memory and executable by the processor to cause the apparatus to:
receive one or more first messages that collectively indicate one or more configurations for communications between a user equipment (UE) and a network entity during a plurality of periodic communication occasions, each configuration of the one or more configurations indicating a respective periodicity associated with the plurality of periodic communication occasions;
receive a control message that activates at least one of the one or more configurations for the communications between the UE and the network entity during the plurality of periodic communication occasions, the control message scheduling multiple instances of the communications; and
communicate, based at least in part on receiving the control message, the multiple instances in accordance with the at least one of the one or more configurations, each of the multiple instances including a different set of transport blocks.

2. The apparatus of claim 1, wherein the instructions to receive the control message are further executable by the processor to cause the apparatus to:
identify a schedule for communicating the multiple instances of the communications, wherein the multiple instances are associated with a same configuration of the one or more configurations and are scheduled within a same periodic communication occasion associated with the same configuration.

3. The apparatus of claim 1, wherein the instructions to receive the control message are further executable by the processor to cause the apparatus to:
identify a schedule for communicating the multiple instances of the communications, wherein the multiple instances are each associated with a respective different configuration of the one or more configurations and are each scheduled within a respective different periodic communication occasion associated with the respective different configuration.

4. The apparatus of claim 1, wherein the instructions to receive the control message are executable by the processor to cause the apparatus to:
receive the control message indicating a plurality of pairs of a start and length indicator value and a corresponding slot offset value, wherein each pair of the plurality of pairs corresponds to an instance of the multiple instances.

5. The apparatus of claim 4, wherein a slot offset value indicates a number of slots between a slot for receiving the control message and a slot for a periodic communication occasion of the plurality of periodic communication occasions and a start and length indicator value indicates a starting symbol and a number of consecutive symbols for communicating an instance of the multiple instances.

6. The apparatus of claim 4, wherein the instructions to communicate the multiple instances are executable by the processor to cause the apparatus to:
communicate the instance of the multiple instances according to a corresponding pair of the plurality of pairs.

7. The apparatus of claim 4, wherein a number of pairs corresponding to the plurality of pairs is equal to a number of configurations corresponding to the at least one of the one or more configurations.

8. The apparatus of claim 4, wherein:
a number of configurations corresponding to the at least one of the one or more configurations indicates a threshold, and
the number of configurations corresponding to the at least one of the one or more configurations or a number of pairs corresponding to the plurality of pairs is equal to or above the threshold.

9. The apparatus of claim 1, wherein resources for communicating the multiple instances comprise resources associated with a same frequency domain resource allocation, a same modulation and coding scheme, or both.

10. The apparatus of claim 1, wherein the instructions are further executable by the processor to cause the apparatus to:
determine a hybrid automatic repeat request process identifier for a first instance of the multiple instances.

11. The apparatus of claim 10, wherein the instructions to determine the hybrid automatic repeat request process identifier are executable by the processor to cause the apparatus to:
input a slot for communicating the first instance of the multiple instances into an algorithm, wherein an output of the algorithm is the hybrid automatic repeat request process identifier.

12. The apparatus of claim 11, wherein the instructions are further executable by the processor to cause the apparatus to:
increment the hybrid automatic repeat request process identifier associated with the first instance by one, wherein a hybrid automatic repeat request process identifier associated with a second instance of the multiple instances comprises the hybrid automatic repeat request process identifier associated with the first instance by one.

13. The apparatus of claim 1, wherein the instructions are further executable by the processor to cause the apparatus to:
transmit a second message comprising feedback information for a first instance of the multiple instances.

14. The apparatus of claim 13, wherein the instructions are further executable by the processor to cause the apparatus to:
determine a slot for transmitting the second message based at least in part on a slot offset value, wherein the slot offset value indicates a number of slots between a slot for communicating the first instance of the multiple instances and a slot for transmitting the second message.

15. The apparatus of claim 14, wherein the instructions are further executable by the processor to cause the apparatus to:
determine, based at least in part on the slot offset value, a slot for transmitting a third message comprising feedback information for a second instance of the multiple instances.

16. The apparatus of claim 14, wherein the second message further comprises feedback information for a second instance of the multiple instances.

17. The apparatus of claim 1, wherein the instructions to receive the control message are executable by the processor to cause the apparatus to:
receive the control message that activates a first configuration and a second configuration of the one or more configurations for communications between the UE and the network entity during the plurality of periodic communication occasions.

18. The apparatus of claim 17, wherein the instructions to communicate the multiple instances are executable by the processor to cause the apparatus to:
communicate a first set of transport blocks in accordance with the first configuration during a periodic communication occasion associated with the first configuration; and
communicate a second set of transport blocks in accordance with the second configuration during a periodic communication occasion associated with the second configuration, wherein the first set of transport blocks is different from the second set of transport blocks.

19. The apparatus of claim 17, wherein a hybrid automatic repeat request process number field included in the control message indicates the first configuration and the second configuration.

20. The apparatus of claim 17, wherein the instructions are further executable by the processor to cause the apparatus to:
deactivate a third configuration of the one or more configurations for communications between the UE and the network entity during the plurality of periodic communication occasions based at least in part on receiving the control message.

21. The apparatus of claim 17, wherein the instructions are further executable by the processor to cause the apparatus to:
deactivate the first configuration and the second configuration based at least in part on an expiration of a timer; and
activate a third configuration for communications between the UE and the network entity during the plurality of periodic communication occasions based at least in part on the expiration of the timer.

22. The apparatus of claim 17, wherein the instructions are further executable by the processor to cause the apparatus to:
deactivate the first configuration and the second configuration for a duration based at least in part on receiving a second control message; and
activate the first configuration and the second configuration based at least in part on expiration of a timer.

23. The apparatus of claim 1, wherein the instructions to receive the control message are further executable by the processor to cause the apparatus to:
receive the control message that activates a single configuration of the one or more configurations for communications between the UE and the network entity during the plurality of periodic communication occasions; and
communicate a first set of transport blocks and a second set of transport blocks in accordance with the single configuration during a periodic communication occasion associated with the single configuration, wherein the first set of transport blocks is different from the second set of transport blocks.

24. An apparatus for wireless communication, comprising:
a processor;
memory coupled with the processor; and
instructions stored in the memory and executable by the processor to cause the apparatus to:
transmit one or more first messages that collectively indicate one or more configurations for communications between a user equipment (UE) and a network entity during a plurality of periodic communication occasions, each configuration of the one or more configurations indicating a respective periodicity associated with the plurality of periodic communication occasions;
transmit a control message that activates at least one of the one or more configurations for the communications between the UE and the network entity during the plurality of periodic communication occasions, the control message scheduling multiple instances of the communications; and
communicate, based at least in part on transmitting the control message, the multiple instances in accordance with the at least one of the one or more configurations, each of the multiple instances including a different set of transport blocks.

25. The apparatus of claim 24, wherein the instructions to transmit the control message are further executable by the processor to cause the apparatus to:
transmit a schedule for communicating the multiple instances of the communications, wherein the multiple instances are associated with a same configuration of the one or more configurations and are scheduled within a same periodic communication occasion associated with the same configuration.

26. The apparatus of claim 24, wherein the instructions to transmit the control message are further executable by the processor to cause the apparatus to:
transmit a schedule for communicating the multiple instances of the communications, wherein the multiple instances are each associated with a respective different configuration of the one or more configurations and are each scheduled within a respective different periodic communication occasion associated with the respective different configuration.

27. A method for wireless communication at a user equipment (UE), comprising:
receiving one or more first messages that collectively indicate one or more configurations for communications between the UE and a network entity during a plurality of periodic communication occasions, each configuration of the one or more configurations indicating a respective periodicity associated with the plurality of periodic communication occasions;
receiving a control message that activates at least one of the one or more configurations for the communications between the UE and the network entity during the plurality of periodic communication occasions, the control message scheduling multiple instances of the communications; and
communicating, based at least in part on receiving the control message, the multiple instances in accordance with the at least one of the one or more configurations, each of the multiple instances including a different set of transport blocks.

28. The method of claim 27, wherein receiving the control message further comprises:
identifying a schedule for communicating the multiple instances of the communications, wherein the multiple instances are associated with a same configuration of the one or more configurations and are scheduled within a same periodic communication occasion associated with the same configuration.

29. A method for wireless communication at a network entity, comprising:
transmitting one or more first messages that collectively indicate one or more configurations for communications between a user equipment (UE) and the network entity during a plurality of periodic communication occasions, each configuration of the one or more configurations indicating a respective periodicity associated with the plurality of periodic communication occasions;
transmitting a control message that activates at least one of the one or more configurations for the communications between the UE and the network entity during the plurality of periodic communication occasions, the control message scheduling multiple instances of the communications; and
communicating, based at least in part on transmitting the control message, the multiple instances in accordance with the at least one of the one or more configurations, each of the multiple instances including a different set of transport blocks.

30. The method of claim 29, wherein transmitting the control message further comprises:
transmitting a schedule for communicating the multiple instances of the communications, wherein the multiple instances are associated with a same configuration of the one or more configurations and are scheduled within a same periodic communication occasion associated with the same configuration.
